(19) United States
(12) Patent Application Publication
(10) Pub. No.: US 2024/0320643 A1
(43) Pub. Date: Sep. 26, 2024

(54) NON-FUNGIBLE TOKEN (NFT)-BASED DIGITAL PRODUCT SUBSCRIPTION MANAGEMENT

(71) Applicant: SONY GROUP CORPORATION, TOKYO (JP)

(72) Inventors: PRATIKA MAHESHWARI, BENGALURU, CA (US); MADHVESH SULIBHAVI, BENGALURU (IN)

(21) Appl. No.: 18/188,771

(22) Filed: Mar. 23, 2023

(51) Int. Cl. G06Q 20/12

(52) U.S. Cl. CPC G06Q 20/1235

(57) ABSTRACT

An electronic device and method for NFT-based digital product subscription management is disclosed. A first subscription request associated with a first user is received, for one or more first digital products. The first subscription request corresponds to a first user-right for the one or more first digital products. A cost associated with the one or more first digital products is determined, based on demand information for the one or more first digital products. Metadata associated with the one or more first digital products is determined, based on the first subscription request and the cost. A second subscription request associated with a second user is received, for a second digital product. The second subscription request corresponds to a second user-right of the second user for the second digital product. A second NFT is retrieved and an ownership or usage of the second digital product is controlled based on the second NFT.

### CROSS-REFERENCE TO RELATED APPLICATIONS/INCORPORATION BY REFERENCE

None

### FIELD

Various embodiments of the disclosure relate to non-fungible tokens (NFTs). More specifically, various embodiments of the disclosure relate to an electronic device and method for NFT-based digital product subscription management.

### BACKGROUND

Advancements in the field of telecommunication have resulted in growth of online delivery of digital products and services (such as, music streaming, video streaming, online games, and the like). Various factors, such as, deeper penetration of Internet among masses, lowered costs of broadband connections, and increased speed of the broadband connections, have contributed to an increased reach of the digital products and services, through online digital delivery platforms. For example, the enhanced speed and demand for a broader array of media products, from sports to movies and entertainment etc., has resulted in increase in the number of digital delivery platforms. The online delivery of digital products and services is now as popular as traditional TV programming and now has a good market share in the screen-based entertainment market segment. For example, various digital services have replaced scheduled broadcasting with on-demand programming. In some instances, due to availability of various digital products (such as, music, video etc.) on different digital platforms (such as, Over-The-Top (OTT) platforms), a user may be required to purchase multiple subscriptions. Due to multiple subscriptions, amount spent by the user for digital services may be increased. In certain cases, the user may not have a requirement for the digital services for a duration of time-period (such as, during a vacation, a certain time of day (such as, at night), a day of week (such as, a weekday), or a month of a year etc.), due to which the amount spent on the subscription may be wasted. Further, there may be interoperability between the various digital delivery platforms.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for non-fungible token (NFT)-based digital product subscription management is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for implementation of non-fungible tokens (NFTs) for management of digital products, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary processing pipeline for implementation of non-fungible tokens (NFTs) for management of digital products on digital platforms, in accordance with an embodiment of the disclosure.

FIG. 4 is a diagram that illustrates an exemplary processing pipeline for transfer of user-rights associated with digital products between two digital platforms, in accordance with an embodiment of the disclosure.

FIG. 5 is a diagram that illustrates an exemplary processing pipeline for user profile-based ownership or usage control of digital products, in accordance with an embodiment of the disclosure.

FIG. 6 is a diagram that illustrates an exemplary processing pipeline to determine reward information based on usage of one or more first digital products, in accordance with an embodiment of the disclosure.

FIG. 7 is a diagram that illustrates an exemplary processing pipeline for reward information determination based on advertisement, in accordance with an embodiment of the disclosure

FIG. 8 is a diagram that illustrates an exemplary processing pipeline for purchase of a digital product based on reward information, in accordance with an embodiment of the disclosure.

FIG. 9 is a diagram that illustrates an exemplary network architecture for NFT-based digital product subscription management, in accordance with an embodiment of the disclosure.

FIG. 10 is a diagram that illustrates an exemplary block diagram for NFT-based digital product subscription management, in accordance with an embodiment of the disclosure.

FIG. 11 is a diagram that illustrates an exemplary block diagram for an AI model, in accordance with an embodiment of the disclosure.

FIG. 12 is a table that illustrates an exemplary data output from the AI model for NFT-based digital product subscription management, in accordance with an embodiment of the disclosure.

FIG. 13 is a diagram that illustrates an exemplary scenario for NFT-based digital product subscription management, in accordance with an embodiment of the disclosure.

FIG. 14 is a diagram that illustrates an exemplary scenario for subscription pack creation, in accordance with an embodiment of the disclosure.

FIG. 15 is a diagram that illustrates an exemplary scenario of pay per use of digital product, in accordance with an embodiment of the disclosure.

FIG. 16 is a diagram that illustrates an exemplary scenario of a digital wallet to make a purchase, in accordance with an embodiment of the disclosure.

FIG. 17 is a diagram that illustrates an exemplary scenario of an interoperability between a virtual NFT and a physical NFT, in accordance with an embodiment of the disclosure.

FIG. 18 is a diagram that illustrates an exemplary scenario of an interoperability between a virtual NFT and a physical NFT, in accordance with an embodiment of the disclosure.

FIG. 19 is a flowchart that illustrates operations of an exemplary method for non-fungible token (NFT)-based digital product subscription management, in accordance with an embodiment of the disclosure.

### DETAILED DESCRIPTION

The following described implementation may be found in the electronic device and method for non-fungible token (NFT)-based digital product subscription management. Exemplary aspects of the disclosure may provide an electronic device for NFT-based digital product subscription management. The electronic device may receive a first subscription request associated with a first user, for one or more first digital products, from a set of digital products associated with a set of digital platforms. The first subscription request may correspond to a first user-right of the first user for the one or more first digital products. Further, the electronic device may determine a cost associated with the one or more first digital products for the first user, based on demand information for the one or more first digital products among the set of digital products associated with the set of digital platforms. Further, the electronic device may determine metadata associated with the one or more first digital products, based on the received first subscription request and the determined cost associated with the one or more first digital products. Further, the electronic device may create one or more first non-fungible tokens (NFTs) associated with the one or more first digital products. Each of the one or more first NFTs may be created based on a storage of the determined metadata to a first distributed ledger associated with each of the set of digital platforms. Further, the electronic device may receive a second subscription request associated with a second user, for a second digital product, from the one or more first digital products, associated with the set of digital platforms. The second subscription request may correspond to a second user-right of the second user for the second digital product. Further, the electronic device may retrieve, from the created one or more first NFTs on the first distributed ledger, a second NFT associated with the second digital product, based on the received second subscription request and control an ownership or a usage of the second digital product associated with the set of digital platforms, based on the retrieved second NFT.

In some instances, due to availability of various digital products (such as streaming music, streaming video etc.) on different digital platforms, user may be compelled to purchase multiple subscriptions. Due to multiple subscriptions, amount spent by the user for digital services may get increased. Further, the user may not have requirement for the digital services for a duration of time-period (such as a time of day, a day of week or a month of a year etc.), due to which the amount spent on the subscription may be wasted. Further, there may be no support for interoperability of services where the user may be able to access different digital products (such as music streaming and playlist that includes music from different digital services etc.) from different digital service platforms.

The disclosed electronic device may create an NFT (e.g., the one or more first NFTs) for each digital product (e.g., the one or more first digital products) of a user (e.g., the first user). The created NFT (e.g., the one or more first NFTs) may be stored on a distributed ledger (e.g., the first distributed ledger). Further, the electronic device may receive a subscription request (e.g., second subscription request) associated with a user (e.g., the second user), for a digital product (e.g., one or more first digital products). To grant a certain user-right to the user for the digital product, the electronic device may retrieve, from the one or more NFTs, an NFT (e.g., the second NFT) corresponding to the particular user-right. Thereafter, the user may be provided with the particular user-right for the digital product. Thus, the disclosed electronic device may control multiple types of user-rights associated with the digital product, based on retrieval of a corresponding NFT associated with the user-right for the digital product that may be available across different platforms. For example, the user may be granted ownership of the digital product for a limited duration of time (such as N number of days, that may correspond to a remainder period of subscription of the product). Further, the electronic device may enable different types of user-rights (e.g., ownership right, renting right, modification right, etc) associated with a digital product to be vested with different users, concurrently. For example, a first user may possess a renting right to a digital product, while a second user may have a modification right to the same digital product, at the same time. Thus, the ownership or the usage rights of the digital products associated with the digital platforms may be controlled and inter-operability of different digital platforms may also be achieved.

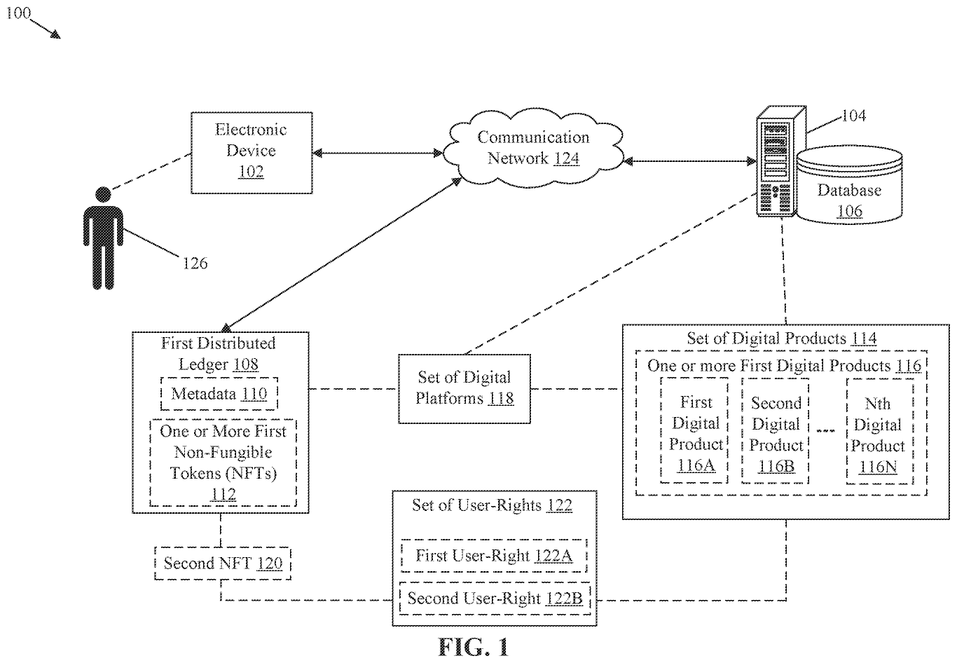

FIG. 1 is a block diagram that illustrates an exemplary network environment for non-fungible token (NFT)-based digital product subscription management, in accordance with an embodiment of the disclosure. With reference to FIG. 1, there is shown a network environment 100. The network environment 100 may include an electronic device 102, a server 104, a database 106, a first distributed ledger 108, and a communication network 124. The electronic device 102, the server 104, and the first distributed ledger 108 may be communicatively coupled to one another, via the communication network 124. The server 104 may include a set of digital products 114 and a set of digital platforms 118. The first distributed ledger 108 may include metadata 110 and one or more first NFTs 112. The set of digital products 114 may include one or more first digital products 116, such as, a first digital product 116A, a second digital product 116B . . . and a Nth digital product 116N.

The first distributed ledger 108 may store metadata 110 and one or more first NFTs 112. In FIG. 1, there is further shown a second NFT 120. The one or more first NFTs 112 and the second NFT 120 may be associated with a set of user-rights 122, which may include user-rights, such as, a first user-right 122A and a second user-right 122B. In FIG. 1, there is further shown a user 126 who may be associated with or operate the electronic device 102.

The N number of digital products shown in FIG. 1 is presented merely as an example. The one or more first digital products 116 may include only one or more than N digital products, without deviation from the scope of the disclosure. For the sake of brevity, only N digital products have been shown in FIG. 1. However, in some embodiments, there may be more than N digital products, without limiting the scope of the disclosure.

The electronic device 102 may include suitable logic, circuitry, interfaces, and/or code that may be configured to receive a first subscription request associated with a first user (e.g., the user 126). The first subscription request may be for the one or more first digital products 116, from the set of digital products 114 associated with the set of digital platforms 118. The first subscription request may correspond to the first user-right 122A of the first user (e.g., the user 126) for the one or more first digital products 116. Further, the electronic device 102 may determine a cost associated with the one or more first digital products 116 for the first user, based on demand information for the one or more first digital products 116 among the set of digital products 114 associated with the set of digital platforms 118. Further, the electronic device 102 may determine metadata 110 associated with the one or more first digital products 116, based on the received first subscription request and the determined cost associated with the one or more first digital products 116. Further, the electronic device 102 may create the one or more first NFTs 112 associated with the one or more first digital products 116. Each of the one or more first NFTs 112 may be created based on a storage of the determined metadata 110 to the first distributed ledger 108 associated with each of the set of digital platforms 118. Further, the electronic device 102 may receive a second subscription request associated with a second user (not shown in FIG. 1), for the second digital product 116B, from the one or more first digital products 116, associated with the set of digital platforms 118. The second subscription request may correspond to the second user-right 122B of the second user for the second digital product 116B. Further, the electronic device 102 may retrieve, from the created one or more first NFTs 112 on the first distributed ledger 108, a second NFT 120 associated with the second digital product 116B, based on the received second subscription request. Examples of the first user-right 122A and second user-right 122B may include, but are not limited to, ownership right, a modification right, a renting right, a time-share right, an exchanging right, or a derivative creation right. Accordingly, the electronic device 102 may control an ownership or a usage of the second digital product 116B associated with the set of digital platforms 118, based on the retrieved second NFT 120.

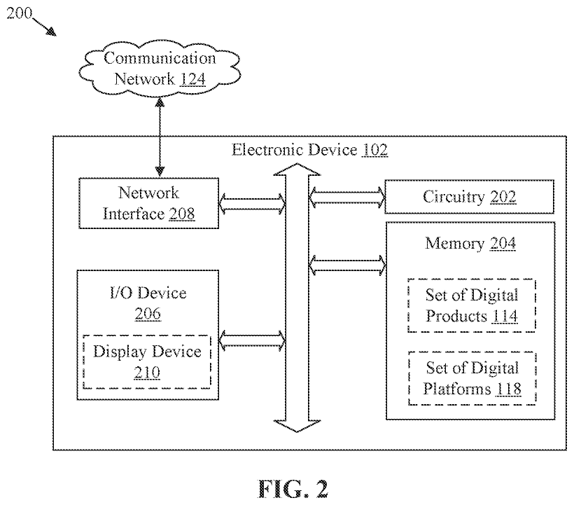

Though the set of digital platforms 118 is shown as associated with or hosted on the server 104 in FIG. 1, in some embodiments, the set of digital platforms 118 may be implemented on the electronic device 102, without a departure from the scope of the disclosure. For example, information related to the set of digital platforms 118 and the set of digital products 114 may be stored on the electronic device 102 (for example, in a memory 204 of FIG. 2) instead of, or in addition to, the server 104 and/or the database 106. In an embodiment, the first user-right 122A may be same as the second user-right 122B. in another embodiment, the first user-right 122A may be different from the second user-right 122B.

Examples of the electronic device 102 may include, but are not limited to, a computing device, a desktop, a personal computer, a laptop, a computer workstation, a tablet computing device, a smartphone, a cellular phone, a mobile phone, a wearable display, a utility device, a utility console, a smart television (TV), an augmented reality (AR)/virtual reality (VR)/mixed reality (MR) device, a head-mounted display (HMD) for utility, a heads-up display (HUD) for utility, smart glasses for utility, a mainframe machine, a server, and/or a consumer electronic (CE) device.

The server 104 may include suitable logic, circuitry, and interfaces, and/or code that may be configured to implement or host the set of digital platforms 118 and store information associated with the set of digital products 114. The server 104 may be configured to create the one or more first NFTs 112 associated with the one or more first digital products 116 based on a storage of the metadata 110 to the first distributed ledger 108 associated with each of the set of digital platforms 118. Further, the server 104 may be configured to retrieve, the second NFT 120 associated with the second digital product 116B from the created one or more first NFTs 112. The server 104 may be configured to control an ownership or a usage of the second digital product 116B associated with the set of digital platforms 118, based on the retrieved second NFT 120. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store information associated with the set of digital platforms 118, the set of digital products 114, and the metadata 110 associated with the set of digital products 114. The database 106 may be derived from data off a relational or non-relational database, or a set of comma-separated values (csv) files in conventional or big-data storage. The database 106 may be stored or cached on a device, such as, a server (e.g., the server 104) or the electronic device 102. The device that stores the database 106 may be configured to receive a query for the information stored on the database 106. Based on the received query, the device of the database 106 may be configured to retrieve and provide the queried information to the electronic device 102 (or the server 104). In some embodiments, the database 106 may be hosted on a plurality of servers stored at same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The first distributed ledger 108 may be a decentralized and distributed database system that may maintain an immutable record of data operations or transactions. For example, the first distributed ledger 108 may include blockchain-based or distributed ledger technology (DLT)-based electronic tokens, such as, the one or more first NFTs 112 and the second NFT 120. A set of data operations may be grouped together as a block and may be further linked to a previous block of data operations to form a chain of a plurality of blocks. All blocks of data operations may be stored in a decentralized manner, whereby all participants or nodes store all the plurality of blocks. Further, the first distributed ledger 108 may include an operating system which may allow for deployment of the group of smart contracts between multiple parties, for example, the user 126, the second user 128, and the electronic device 102. In some implementations, different nodes of the first distributed ledger 108 may be owned and/or operated by different entities, such as, businesses or individuals. In some implementations, all of the nodes of the first distributed ledger 108 may be owned and/or operated by a single entity, such as a digital platform, a content creator, or digital platform provider. The first distributed ledger 108 may be a chain of blocks which uses accounts as state objects such that a state of each account may be tracked by the chain. The accounts represent identities of users, mining nodes, or automated agents. All the blocks of data operations or the smart contract are associated with the accounts on the chain of blocks.

By way of example, and not limitation, the first distributed ledger 108 may be an Ethereum blockchain, which may use accounts as state objects such that a state of each account may be tracked by the Ethereum blockchain. The accounts may represent identities of users, mining nodes, or automated agents. All the blocks of data operations or the smart contract may be associated with the accounts on the Ethereum Blockchain. The scope of the disclosure may not be limited to the implementation of the first distributed ledger 108 as the Ethereum blockchain. Other implementations of the first distributed ledger 108 may be possible (for example, a Hyperledger blockchain or a Corda blockchain) in the present disclosure, without a deviation from the scope of the present disclosure.

Each of the set of digital products 114 may include logic circuitry, and interface, and/or code that may be configured to provide an interface through which a user (for example, the user 126) may access or request utility services. The set of digital products 114 may include, but are not limited to, a television service (such as, a broadcast news channel), a streaming media service (such as, music or video streaming), an Over-The-Top (OTT) service (such as, media services offered directly to viewers via the internet), a utility service (such as, online utility), a digital artwork (such as an image, an icon and the like), an online food delivery service, an online groceries delivery service, an e-commerce service, a commission-based service, a pay-per-use service, a subscription-based service, or an NFT-based content, product or service.

In an embodiment, each of the set of digital products 114 may be associated with the first distributed ledger 108. In an embodiment, the set of digital products 114 may be implemented or hosted on the server 104. Additionally, or alternatively, the set of digital products 114 may be implemented or hosted on the electronic device 102. In such case, information related to the set of digital products 114 and the set of digital platforms 118 may be stored on a memory (e.g., a memory 204 of FIG. 2) of the electronic device 102.

Each of the set of digital platforms 118 may include logic, circuitry, and interfaces, and/or code that may be configured to host a service or an application programming interface (API) through which a user (e.g., the user 126) may interact with the set digital products 114. For example, a digital platform may correspond to an online portal that may facilitate a provision of media content, digital products, and/or digital services from content creators to content consumers. In other cases, the digital platform may also host online games from multiple companies.

In an embodiment, each of the set of digital platforms 118 may be associated with the first distributed ledger 108 and the set of digital products 114. In an embodiment, the set of digital platforms 118 may be implemented or hosted on the server 104. Additionally, or alternatively, the set of digital platforms 118 may be implemented or hosted on the electronic device 102. In such case, information related to the set of digital platforms 118 and the set of digital products 114 may be stored on a memory (e.g., a memory 204 of FIG. 2) of the electronic device 102.

The communication network 124 may include a communication medium through which the electronic device 102, the server 104, and the first distributed ledger 108 may communicate with one another. The communication network 124 may be one of a wired connection or a wireless connection. Examples of the communication network 124 may include, but are not limited to, the Internet, a cloud network, Cellular or Wireless Mobile Network (such as, Long-Term Evolution and 5th Generation (5G) New Radio (NR)), a satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 124 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

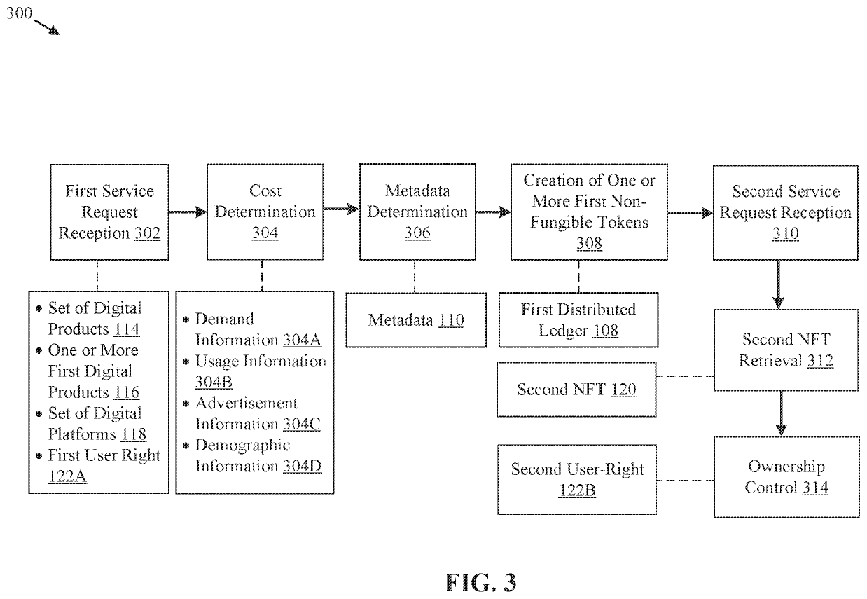

In operation, the electronic device 102 may be configured to receive a first subscription request associated with a first user (e.g., the user 126), for the one or more first digital products 116, from the set of digital products 114 associated with the set of digital platforms 118. The first subscription request may correspond to the first user-right 122A of the first user (e.g., the user 126) for the one or more first digital products 116. The reception of the first subscription request is described further, for example, in FIG. 3 (at 302).

The electronic device 102 may be configured to determine a cost associated with the one or more first digital products 116 for the first user (e.g., the user 126), based on demand information for the one or more first digital products 116 among the set of digital products 114 associated with the set of digital platforms 118. The determination of the cost of the one or more first digital products is described further, for example, in FIG. 3 (at 304).

The electronic device 102 may be configured to determine the metadata 110 associated with the one or more first digital products 116, based on the received first subscription request and the determined cost associated with the one or more first digital products 116. The determination of the metadata is described further, for example, in FIG. 3 (at 306).

The electronic device 102 may create the one or more first NFTs 112 associated with the one or more first digital products 116. Each of the one or more first NFTs 112 may be created based on a storage of the determined metadata 110 to the first distributed ledger 108 associated with each of the set of digital platforms 118. The creation of the one or more first NFTs is described further, for example, in FIG. 3 (at 308).

The electronic device 102 may be configured to receive a second subscription request associated with a second user (not shown in FIG. 1), for a second digital product 116B, from the one or more first digital products 116, associated with the set of digital platforms 118. The second subscription request may correspond to the second user-right 122B of the second user for the second digital product 116B. The reception of the second subscription request is described further, for example, in FIG. 3 (at 310).

Further, the electronic device 102 may retrieve, from the created one or more first NFTs 112 on the first distributed ledger 108, the second NFT 120 associated with the second digital product 116B, based on the received second subscription request. Examples of the first user-right 122A and second user-right 122B may include, but are not limited to, ownership right, a modification right, a renting right, a time-share right, an exchanging right, or a derivative creation right. The retrieval of the second NFT is described further, for example, in FIG. 3 (at 312).

, The electronic device 102 may control an ownership or a usage of the second digital product 116B associated with the set of digital platforms 118, based on the retrieved second NFT 120. The control of the ownership or usage of the second digital product is described further, for example, in FIG. 3 (at 314).

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the exemplary electronic device 102. The electronic device 102 may include circuitry 202, a memory 204, an input/output (I/O) device 206, and a network interface 208. The memory 204 may include information related to the set of digital products 114 and the set of digital platforms 118, and the input/output (I/O) device 206 may include a display device 210. The network interface 208 may connect the electronic device 102 with the first distributed ledger 108 and the server 104, via the communication network 124.

The circuitry 202 may include suitable logic, circuitry, and/or interfaces that may be configured to execute program instructions associated with different operations to be executed by the electronic device 102. The operations may include reception of the first subscription request, determination of the cost associated with the one or more first digital products 116, determination of the metadata 110, creation of the one or more first NFTs 112, reception of the second subscription request, retrieval of the second NFT 120, and control of the ownership or usage of the second digital product 116B. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may execute different operations of the circuitry 202 (and/or the electronic device 102). The memory 204 may be configured to store information related to the set of digital platforms 118. Further, the memory 204 may store information related to the set of digital products 114 and the metadata 110 associated with the one or more first digital products 116. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a user input indicative of a selection of a digital platform and a digital product by a user (such as, the first user, e.g., the user 126). The user input may further include a selection of a user-right associated with the selected digital product that may be required to be controlled or transferred. The I/O device 206 may be further configured to display a user-interface associated with the set of digital platforms 118 and the selected digital product. The I/O device 206 may include various input and output devices, which may be configured to communicate with the circuitry 202. The I/O device 206 may include the display device 210. Examples of the I/O device 206 may include, but are not limited to, a touch screen, the display device 210, a keyboard, a mouse, a joystick, a microphone, or a speaker. Examples of the I/O device 206 may further include braille I/O devices, such as, braille keyboards and braille readers.

The network interface 208 may include suitable logic, circuitry, interfaces, and/or code that may be configured to facilitate communication between the electronic device 102, the first distributed ledger 108, and the server 104. The network interface 208 may be implemented by use of various known technologies to support wired or wireless communication of the electronic device 102 with the communication network. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display the user-interface associated with the set of digital platforms 118 and the first digital product 116A. The display device 210 may be a touch screen which may enable a user (e.g., the user 126) to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for NFT-based digital product subscription management are described further, for example, in FIGS. 3, 4, 5, 6, 7 and 8.

FIG. 3 is a diagram that illustrates an exemplary processing pipeline for NFT-based digital product subscription management, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 314 for NFT-based digital product subscription management. The exemplary operations 302 to 314 may be executed by any computing system, for example, by the electronic device 102 of FIG. 1 or by the circuitry 202 of FIG. 2.

At 302, an operation for first service request reception may be executed. The circuitry 202 may be configured to receive a first subscription request associated with a first user (e.g., the user 126), for the one or more first digital products 116, from the set of digital products 114 (such as, a streaming media service, an Over-The-Top (OTT) service, a music streaming service, a utility service, and the like) associated with the set of digital platforms 118 (such as, a streaming service platform, utility service platform, an OTT service platform, and the like). For example, the first subscription request may correspond to transfer of user rights associated with a product from one user to another user for a limited period of time (for example, in case of a lease of the product) or permanently (for example, in case of an exchange or sale of the product).

The first subscription request may correspond to the first user-right 122A (such as, an ownership right, a modification right, and the like) of the first user (e.g., the user 126) for the one or more first digital products 116. For example, the set of digital products 114 may correspond to a utility service (such as, music streaming service, video streaming service, and the like) and the set of digital platforms 118 may correspond to a utility application.

It may be appreciated that the set of digital products 114 may be accessed using the set of digital platforms 118. For example, the utility service of the set of digital products 114 may be accessed using the utility application of the set of digital platforms 118. The utility application (such as, a music streaming service) may be an application that may be used to access a utility service (such as, a service that provides hosted music content) on a computing device (e.g., the electronic device 102) of the first user (e.g., the user 126). The first user (e.g., the user 126) may use the utility application to access the utility service through the computing device (e.g., the electronic device 102). Examples of the utility service may include, but are not limited to, a television service (such as broadcast news channel), a streaming media service (such as, music or video streaming), an Over-The-Top (OTT) service a digital artwork (such as an image, an icon, and the like), an online food delivery service, an online groceries delivery service, an e-commerce service, a commission-based service, a pay-per-use service, a subscription-based service, or an NFT-based product or service or content (for example, NFT-based gaming, music streaming, or artwork).

In another example, the set of digital platforms 118 may correspond to a virtual reality world including a virtual land or virtual estate as digital products. A user (e.g., the first user, such as, the user 126) may own a virtual estate as a digital product, such as, the first digital product 116A. The first digital product 116A may have associated user-rights (such as, the first user-right 122A). Examples of the user-rights may include, but are not limited to, construction rights for the virtual estate, renting rights for the virtual estate, mineral extraction or mining rights for the virtual estate, air rights to construct multi-storied virtual buildings up to a certain height, break building codes or zoning ordinances, underground rights for the virtual estate, or rights to block flights over the virtual estate.

At 304, an operation for cost determination may be executed. The circuitry 202 may be configured to determine a cost associated with the one or more first digital products 116 for the first user (e.g., the user 126), based on demand information 304A for the one or more first digital products 116 among the set of digital products 114 associated with the set of digital platforms 118. For example, the cost associated with each of the set of digital products 114 may be dynamic and may correspond to the demand information 304A. For example, the cost of the one or more first digital products 116 may be high if demand for such products is high. In an embodiment, the demand information may correspond to at least one of, but not limited to, usage information indicative of a usage of the set of digital products 114 by a set of users associated with the set of digital platforms 118, advertisement information associated with the set of digital products 114, or demographic information of the set of users associated with the set of digital platforms 118. For example, the demand information 304A may correspond to usage information 304B, including a usage of the set of digital products 114. In an example, if digital product is accessed more than a certain number of times by the set of users, a usage/demand for the digital product may correspond to a high value. In such case, the cost of the one or more first digital products 116 may also be set to a higher value.

The demand information 304A may further correspond to advertisement information 304C associated with the set of digital products 114. It may be appreciated that if advertisement campaigns (such as, weekend offers, festive offers, etc.) are run for products then demand associated with the related products may be increase as compared to a scenario where there are less, or no advertisements related to the products. As the demand information becomes higher, the cost of the products may also be rise.

The demand information 304A may further corresponds to demographic information 304D (such as an age, a gender, a topology) of the set of users associated with the set of digital platforms 118. The demand information 304A may further be based on the demographic information 304D of the set of users. For example, the age, gender topology etc., related information of the set of users may be utilized to generate the demand information 304A. For example, if any digital product from the one or more first digital products 116 is popular amongst users of certain age and gender, then in such a scenario the demand for the product amongst such users may be higher. As the demand information 304A may be higher, the cost of the one or more first digital products 116 may also be higher.

At 306, an operation for metadata determination may be executed. The circuitry 202 may be configured to determine metadata (e.g., the metadata 110) associated with the one or more first digital products 116. The determination of the metadata 110 associated with the one or more first digital products 116 may be based on the received first subscription request and the determined cost associated with the one or more first digital products 116. In an example, the set of digital platforms 118 may correspond to a utility application, such as, OTT application and the first digital product 116A may be a utility service, such as, an OTT streaming service (e.g., a video streaming service). In such case, the metadata 110 may include properties of the first digital product 116A. The metadata 110 may include a name of the first digital product 116A (a video streaming service), a subscription pack for an individual, a duration of the subscription pack (for example for 15 days), value of subscription pack (for example, $25), and other subscription details. In an embodiment, the determination of the metadata 110 may be triggered based on the receipt of the first subscription request or may be triggered periodically after a predefined time interval. In another example, the utility application may be a music streaming application and the utility platform may be a common platform that allows music from different music streaming applications to be consumed through the common platform. In such a case, the metadata 110 may include properties associated with the music tracks, that may include, name of song, name of artist, identity of the music platform on which a music track is available, subscription cost, download cost, and the like.

At 308, an operation for creation of one or more first NFTs may be executed. The circuitry 202 may be configured to create the one or more first NFTs (e.g., the one or more first NFTs 112), associated with the first digital product 116A, based on the determined metadata 110. The one or more first NFTs 112 may be created based on a storage of the determined metadata 110 to a first distributed ledger (e.g., the first distributed ledger 108) associated with each of the set of digital platforms (e.g., the set of digital platforms 118). It may be appreciated that an NFT (e.g., the one or more first NFTs 112) may be a non-interchangeable and non-fungible unit of data that may be stored on a distributed ledger (e.g., the first distributed ledger 108). Examples of the data unit associated with NFTs may include, but are not limited to, photos, videos, audio files, documents, utility assets, virtual estates, and other digital assets. The NFT may be traded and the owner of the NFT or the buyer of the NFT may have rights over the NFT. For example, the first digital product 116A may be a virtual football object of an online football game and the metadata 110 associated with the virtual football object includes a shape (such as, circular), a color (such as, white), and a name (such as, a football). In such case, the circuitry 202 may store the metadata 110 of the virtual football to the first distributed ledger 108 to create an NFT associated with the virtual football object.

At 310, an operation for second service request reception may be executed. The circuitry 202 may be configured to receive a second subscription request associated with a second user for a second digital product 116B (from the one or more first digital products 116, associated with the set of digital platforms 118). The second subscription request may correspond to a second user-right 122B of the second user for the second digital product 116B. For example, the one or more first NFTs 112 may be associated with the set of user-rights 122. A first NFT of the one or more first NFTs 112 may be associated with the first user-right 118A, and the second NFT 120 may be associated with the second user-right 118B. Examples of the set of user-rights 122 may include, but are not limited to, an ownership right, a modification right, a renting right, a time-share right, an exchanging right, or a derivative creation right.

For example, the first user-right 122A (corresponding to the first NFT) may be associated with an ownership right of the first digital product 116A, while the second user-right 122B (corresponding to the second NFT 120) may be associated with a modification right of the first digital product 116A. The ownership right associated with a digital product may be a right of a user to possess the digital product subject to certain conditions. For example, the user may be allowed to possess the digital product with or without a right to rent out or modify the ownership right. The modification right associated with a digital product may be a right of a user to modify the digital product, irrespective of whether the user has an ownership right, or a renting right associated with the digital product. The renting right may allow a digital product and an associated NFT (e.g., a first NFT) to be rented to a user for a certain period of time. When the first NFT is rented, the user to whom the first NFT is rented may have ownership rights over the first digital product 116A for the period for which the first digital product 116A is rented to the user. On the other end, during the period when the first digital product 116A is rented, the original owner of the first digital product 116A may not have the ownership rights over the first digital product 116A. In certain cases, a portion of the first digital product 116A (e.g., a fraction of a total area of a virtual estate) may be rented. In such case, the first NFT may correspond to a fungible token or a non-fungible token. The time-share right may allow a user to share an ownership of a digital product with another user on a time-shared basis for a certain time period, such that at any point of time in the given time period only one of the users may possess and/or use the digital product. The derivative creation right may allow a user a right to create a new digital product, based on the first digital product 116A. For example, an original digital product may be a digital art created by an artist. Based on the derivative creation right on the digital product, the user may embed the digital art in an electronic brochure to create a derived digital art. In certain cases, the creator of the derivative work may be a partial owner of the derivative work, along with the artist of the original work. Thus, separate NFTs may be created to grant separate user-rights associated with the first digital product 116A to one or more users. Hence, for a certain digital product (e.g., the first digital product 116A), a first right (e.g., the ownership right) may be assigned to one user and a second right (e.g., the modification right) may be assigned to another user, based on a transfer of the corresponding NFTs (such as, the first NFT and the second NFT 120, respectively) to the respective users.

In an embodiment, the first digital product 116A may be partially owned by a plurality of users. In such case, each user of the plurality of users may own a predefined portion (e.g., an equal share) of the first digital product 116A. The first digital product 116A may be concurrently used by one or more of the plurality of users on the set of digital platforms. In such case, an NFT (e.g., the one or more first NFTs 112) associated with the first digital product 116A may be a fungible token or a non-fungible token. For example, a digital product, such as, a virtual estate in the set of digital platforms may be owned by three users, such that each of the three users may own 33.33% of the share of the virtual estate. Thus, the virtual estate may be used concurrently by any or all of the three owners of the virtual estate. In an embodiment, the plurality of users, who partially own the first digital product 116A, may include the first user (e.g., the user 126). In such case, the first user may also own a portion of the first digital product 116A along with other users in the plurality of users. In another embodiment, the plurality of users, who partially own the first digital product 116A, may not include the first user. In such case, the first user may not own any portion of the first digital product 116A.

In an embodiment, a semi-fungible token may be associated with the first digital product 116A on the set of digital platforms 118. The semi-fungible token may correspond to a predefined number of copies of the first digital product 116A on the set of digital platforms. For example, a game asset may include a digital collectible, such as, a scroll or a painting, as an in-game content that may be owned by players of a utility application (i.e., an online gaming platform). A limited number of the digital collectible artifacts or assets may be created for the utility application and auctioned or earned by the players during gameplay. For example, 100 copies of the digital collectible may be created. A player may own at most N copies (e.g., 10 copies) of the digital collectible. Also, there may be a maximum of at most M players (e.g., 100 players) who may own the digital collectible concurrently. Further, each copy of the digital collectible (and associated NFT) may be uniquely numbered (such as, 15 of 100). The digital collectible may be represented by a semi-fungible token and each copy of the digital collectible may be represented as an NFT.

At 312, an operation to retrieve a second NFT may be executed. The circuitry 202 may be configured to retrieve a second NFT (e.g., the second NFT 120) associated with the first digital product 116A, based on a user input from the first user (e.g., the user 126). The first distributed ledger 108 may include the one or more first NFTs 112 stored in the first distributed ledger 108. The circuitry 202 may receive a user input indicative of a request to enable a certain user-right associated with the first digital product 116A in the set of digital platforms 118. For example, the user-input may indicate that the user 126 may wish to enable/purchase modification rights associated with a certain digital product (such as, a virtual estate). The circuitry 202 may determine an NFT, from the one or more first NFTs 112, that may be associated with the user-rights that may be required to be enabled/purchased. For example, the circuitry 202 may determine that the second NFT 120 may be associated with a user-right (e.g., the second user-right 122B) that may be requested by the user 126. The circuitry 202 may retrieve the second NFT 120 from the one or more first NFTs 112 stored on the first distributed ledger 108. The circuitry 202 may request the first distributed ledger 108 to retrieve the second NFT 120. The first distributed ledger 108 may verify whether the request of the circuitry 202 is legitimate or not and may further retrieve and transmit the retrieved second NFT 120 to the circuitry 202, based on the verification.

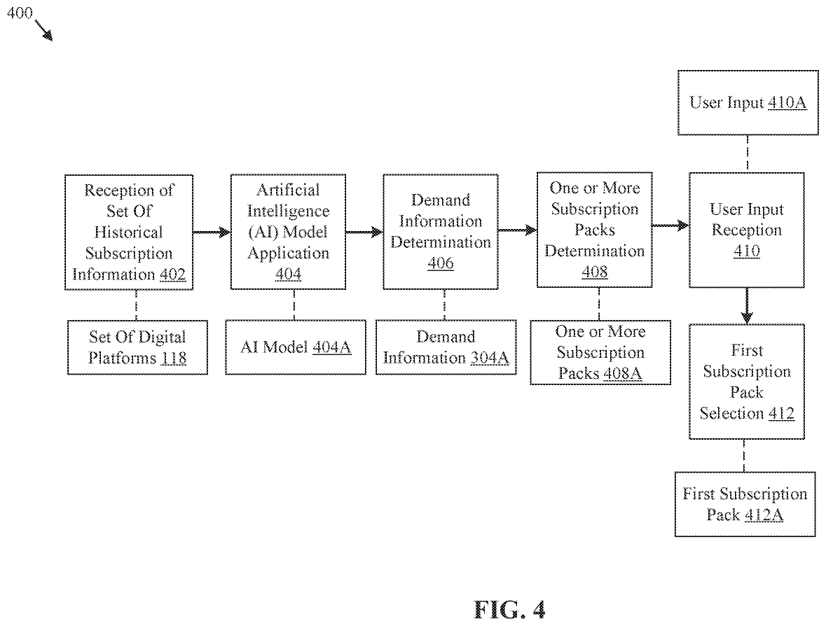

At 314, an operation for ownership or usage control may be executed. The circuitry 202 may be configured to control an ownership or a usage of the second digital product 116B associated with the set of digital platforms 118, based on the retrieved second NFT 120. Once the second NFT 120 is retrieved, the circuitry 202 may control the ownership or usage of the second digital product 116B, based on the corresponding user-right (e.g., the second user-right 122B) associated with the second NFT 120. For example, the second NFT 120 may be associated with the second user-right 122B, which may provide rental rights associated with the first digital product 116A (e.g., a virtual estate). Based on the retrieval of the second NFT 120, the circuitry 202 may control the ownership or usage of the first digital product 116A (e.g., the virtual estate) to provide rental rights (i.e., associated with the virtual estate) to the user 126 on the set of digital platforms 118. Details related to the management of digital products based on NFTs are described further, for example, in FIGS. 4, 5, 6, 7 and 8.

Typically, a digital platform may be associated with multiple digital products, which may be difficult to manage due to a large number of users and various types of operations that may be feasible on each digital product. The disclosed electronic device 102 may create an NFT (e.g., the one or more first NFTs 112) for each digital product (e.g., the first digital product 116A) of a user (e.g., the user 126). The created NFT (e.g., the one or more first NFTs 112) may be stored on a distributed ledger (e.g., the first distributed ledger 108). Further, each of the created NFT (e.g., the one or more first NFTs 112) may correspond to a user-right associated with the digital product. The one or more first NFTs 112 may also be stored on the first distributed ledger 108. To grant a certain user-right to the user 126 for the digital product, the electronic device 102 may retrieve, from the one or more first NFTs 112, an NFT (e.g., the second NFT 120) corresponding to the particular user-right (e.g., the first user-right 122A). Thereafter, the user 126 may be provided with the particular user-right (e.g., the first user-right 122A) for the digital product (e.g., subscription of music streaming service). Thus, the disclosed electronic device 102 may control multiple types of user-rights associated with the digital product, based on corresponding NFTs associated with the set of user-rights 122 for the digital product. For example, the user 126 may be granted an ownership right with respect to a digital product but may not be granted a modification right with respect to the same digital product. In another scenario, one user may be granted ownership right for a digital product and another user may be granted only rental rights for the digital product. Hence, the ownership or usage rights of digital products associated with a digital platform may be granularly controlled and effectively managed. Further, the granting of user-rights associated with each of the set of digital products 114 to users may be agnostic of individual digital platforms of the set of digital platforms 118, which offer the set of digital products 114. Thus, inter-operability between the set of digital platforms 118 for the set of digital products 114 may be achieved.

FIG. 4 is a diagram that illustrates an exemplary processing pipeline for determination of demand information based on the historical subscription information, in accordance with an embodiment of the disclosure. FIG. 4 is explained in conjunction with elements from FIG. 1, FIG. 2, and FIG. 3. With reference to FIG. 4, there is shown an exemplary processing pipeline 400 that illustrates exemplary operations from 402 to 412 determination of demand information based on the historical subscription information. The exemplary operations 402 to 412 may be executed by any computing system, for example, by the electronic device 102 of FIG. 1 or by the circuitry 202 of FIG. 2.

At 402, an operation for reception of a set of historical subscription information may be executed. The circuitry 202 may be configured to receive a set of historical subscription information related to a set of users associated with the set of digital platforms 118. The set of historical subscription information may correspond to subscription information of the set of users over a time-period. For example, during certain days (such as, a holiday or festive season, for example, Christmas and new year holidays) it may be observed that a greater number of users subscribe to the set of digital platforms 118 as compared to other days. The historical subscription information may be acquired iteratively after a predefined time-period (for example, time of day, day of week or day of year). The retrieved historical subscription information may be stored on the database 106 or the memory 204. In an embodiment, the set of historical subscription information reception may be triggered based on the reception of the first subscription request associated with the first user.

In some cases, for a digital content that is recently available on the set of digital platforms 118, it may be difficult to determine demand information for that the digital content. In such scenarios, the set of historical subscription information may correspond to ratings (for example, likes or dislikes etc.) associated with the digital content available on the set of digital platforms 118. In an embodiment, the rating may also be determined analytically based on analysis of biometric data (such as facial expression, emotional expression, or feature extraction) of a person who accesses the digital content. In an embodiment, the biometric data (such as facial expression, emotional expression, or feature extraction) may be acquired when the digital content is accessed by a user. In another embodiment, the biometric data may be acquired after the user accesses the digital content. For example, an image of the person while the digital content (watching video content) is accessed may be captured. The captured image of the person may be analyzed to determine if the digital content is appreciated.

At 404, an operation for AI model application may be executed. The circuitry 202 may be configured to apply an AI model 404A on the received set of historical subscription information. The AI model 404A a classifier/regression/clustering model which may be trained to identify a relationship between inputs, such as features in a training dataset and output labels, such as subscription patterns and demand patterns related to the subscription of the set of digital products 114. The AI model 404A may be defined by its hyper-parameters, for example, number of weights, cost function, input size, number of layers, and the like. The parameters of the AI model 404A may be tuned and weights may be updated so as to move towards a global minima of a cost function for the AI model 404A. After several epochs of the training on the feature information in the training dataset, the AI model 404A may be trained to output a prediction/classification result for a set of inputs. The prediction result may be indicative of a class label for each input of the set of inputs (e.g., input features extracted from new/unseen instances). For example, the AI model 404A may correspond to at least one of, but not limited to, a linear regression model, a decision tree model, a random forest model, a neural network model, a deep learning model, a logistic regression model, a Support Vector Machine (SVM) model, a Naïve Bayes model, a k-means clustering model, a hierarchal clustering model, a mean shift clustering model, a density-based clustering model, or a dimensionality reduction model (such as, a Principal Component Analysis (PCA) model).

The AI model 404A may include electronic data, which may be implemented as, for example, a software component of an application executable on the electronic device 102. The AI model 404A may rely on libraries, external scripts, or other logic/instructions for execution by a processing device, such as, the circuitry 202. The AI model 404A may include code and routines configured to enable a computing device, such as, the circuitry 202, to perform one or more operations to determine the demand information 304A. Additionally or alternatively, the AI model 404A may be implemented using hardware including a processor, a microprocessor (e.g., to perform or control performance of one or more operations), a field-programmable gate array (FPGA), or an application-specific integrated circuit (ASIC). Alternatively, in some embodiments, the AI model 404A may be implemented using a combination of hardware and software.

The AI model 404A may be trained on the set of historical subscription information related to users other than the user 126 in the set of users. For example, the AI model 404A may be trained based on a pre-stored historical subscription information associated with the other users, that may be received and stored over a time-period. The AI model 404A may determine pattern associated with subscription with respect to time of day, date of year, and the like. For example, the AI model 404A may determine patterns such as at what time of day and day of week or month or year users purchase subscriptions.

At 406, an operation for demand information determination may be executed. The circuitry 202 may be configured to determine the demand information 304A based on the application of the AI model 404A. For example, the cost associated with each of the set of digital products 114 may be dynamic and may correspond to the demand information 304A. For example, the cost of the one or more first digital products 116 may be high if a value of demand for the one or more first digital products 116 is high. It may be appreciated that the demand information may correspond to a subscription pattern of products by other users, as determined based on the application of the AI model 404A on the received set of historical subscription information. Details related to the demand information are provided, for example, in FIG. 3.

At 408, an operation for one or more subscription packs determination may be executed. The circuitry 202 may be configured to determine one or more subscription packs (e.g., one or more subscription packs 408A) associated with the one or more first digital products 116, based on the determined demand information 304A and the received first subscription request. For example, the user 126 may have a subscription for a digital product (for example, a video streaming service) for a certain period (e.g., 3 months), however, during a portion of the period (e.g., 10 days), the user 126 may not be available to use the subscription. The circuitry 202 may receive the first subscription request from the user 126 to sell or lease the subscription for the digital product, for the particular portion (e.g., 10 days) of the entire period (e.g., 3 months). In case, the AI model 404A may determine that demand for subscription for the particular digital product (for example, the video streaming service) is high for the 10 days related to the period when the user 126 is unavailable. In such case, as the demand for the digital product is higher for the 10 days, the cost for the subscription pack for the 10-day period may be higher. In an example, based on the first subscription request from the user 126, one or more subscription packs, such as, a streaming video service pack for 10 days for 3 US Dollars or a service pack for 7 days for 2 US Dollars, may be determined.

At 410, an operation for user input reception may be executed. The circuitry 202 may be configured to receive a user input 410A indicative of a selection of a first subscription pack 412A from the determined one or more subscription packs 408A. In an example, two subscription packs (such as, a first pack of 1 US Dollar for 5 days and a second pack of 2 US Dollars for 8 days) may be generated for a digital product (such as, a music streaming service). The user input 410A may correspond to a selection of the first pack of 1 US Dollar for 5 days. Based on the user input 410A, the first pack may be selected from the two subscription packs.

At 412, an operation for first subscription pack selection may be executed. the circuitry 202 may be configured to select the first subscription pack 412A from the determined one or more subscription packs 408A, based on the received user input 410A indicative of the selection of the first subscription pack 412A. For example, the determined one or more subscription packs 408A may include two subscription packs, such as, a first pack of 1 US Dollar for 5 days and a second pack of 2 US Dollars for 8 days. The received user input 410A may correspond to a user selection of the first pack. Based on such received user input 410A, the first pack of 1 US Dollar for 5 days may be determined as the selected first subscription pack 412A.

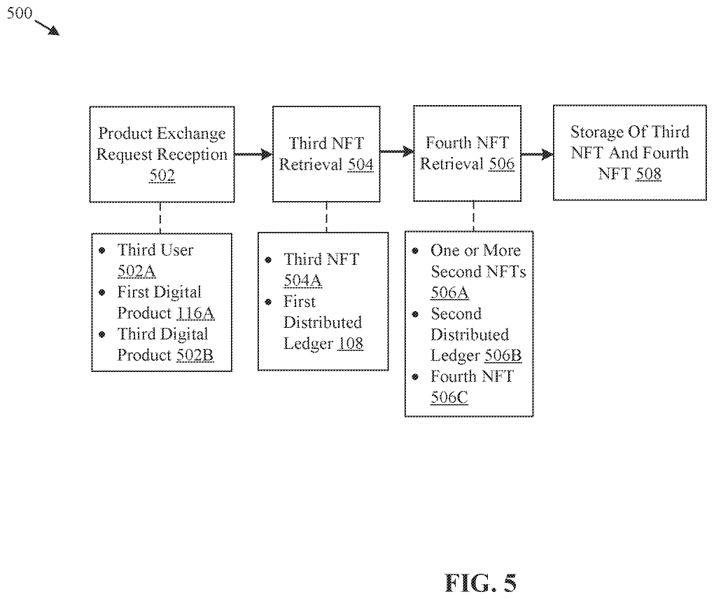

FIG. 5 is a diagram that illustrates an exemplary processing pipeline for exchange of digital products, in accordance with an embodiment of the disclosure. FIG. 5 is explained in conjunction with elements from FIG. 1, FIG. 2, FIG. 3, and FIG. 4. With reference to FIG. 5, there is shown an exemplary processing pipeline 500 that illustrates exemplary operations from 502 to 508 for exchange of digital products. The exemplary operations 502 to 508 may be executed by any computing system, for example, by the electronic device 102 of FIG. 1 or by the circuitry 202 of FIG. 2.

At 502, an operation for product exchange request reception may be executed. The circuitry 202 may be configured to receive a product exchange request associated with the first user (e.g., the user 126), for exchange of the first digital product 116A with a third digital product 502B. The one or more first digital products 116 may include the first digital product 116A, and one or more second digital products associated with a third user (e.g., a third user 502A) include the third digital product 502B. For example, an exchange request may be raised by the first user. The exchange request may be for exchange of the first digital product 116A (such as, a video streaming application) with the third digital product 502B (such as, a music streaming application). in an example, a user “A” might have subscribed to a digital product “X” (such as, the video streaming application) and a user “B” might be subscribed to a digital product “Y” (such as, the music streaming application). In case, the user “B” goes on a vacation for 10 days, the user “B” may not require subscription of the digital product “Y” for that duration. However, the user “B” may require subscription for the product “X” (such as, the music streaming application) for the period of 10 days during the vacation. In such case, the user “A” and the user “B” may wish to exchange the subscription for the corresponding products for the duration of 10 days.

At 504, an operation for third NFT retrieval may be executed. The circuitry 202 may be configured to retrieve, from the one or more first NFTs 112 on the first distributed ledger 108, a third NFT (e.g., a third NFT 504A) associated with the first digital product 116A. The circuitry 202 may retrieve the third NFT 504A from the one or more first NFTs 112 stored on the first distributed ledger 108. For example, the circuitry 202 may request the first distributed ledger 108 for the third NFT 504A. The first distributed ledger 108 may verify whether the request from the circuitry 202 is legitimate or not and may further retrieve and transmit the retrieved third NFT 504A to the circuitry 202, based on the verification. The retrieved third NFT 504A may be associated with a user-right (e.g., the set of user-rights 122), such as, an access right and/or a modification right associated with the third digital product 502B.

At 506, an operation for fourth NFT retrieval may be executed. The circuitry 202 may be configured to retrieve, from one or more second NFTs 506A on a second distributed ledger 506B, a fourth NFT 506C associated with a third digital product 502B. The circuitry 202 may retrieve the fourth NFT 506C from the one or more second NFTs 506A stored on the second distributed ledger 506B. For example, the circuitry 202 may request the second distributed ledger 506B for the fourth NFT 506C. The second distributed ledger 506B may verify whether the request from the circuitry 202 is legitimate or not and may further retrieve and transmit the retrieved fourth NFT 506C to the circuitry 202, based on the verification. The retrieved fourth NFT 506C may be associated with a user-right (e.g., the set of user-rights 122), such as, an access right and/or a modification right associated with the third digital product 502B.

At 508, an operation for the third NFT 504A and the fourth NFT 506C storage may be executed. The circuitry 202 may be configured to store the retrieved third NFT 504A on the second distributed ledger 506B and store the retrieved fourth NFT 506C on the first distributed ledger 108. The first digital product 116A may be exchanged with the third digital product 502B, based on the storage of the third NFT 504A on the second distributed ledger 506B and the storage of the fourth NFT 506C on the first distributed ledger 108. Once the third NFT 504A is retrieved from the first distributed ledger 108, the circuitry 202 may transmit the retrieved third NFT 504A to the second distributed ledger 506B for storage. In some embodiments, the circuitry 202 may request the first distributed ledger 108 to directly transfer the third NFT 504A to the second distributed ledger 506B for storage. In such case, the first distributed ledger 108 may transmit the third NFT 504A to the second distributed ledger 506B, based on the request received from the circuitry 202. Similarly, once the fourth NFT 506C is retrieved from the second distributed ledger 506B, the circuitry 202 may transmit the retrieved fourth NFT 506C to the first distributed ledger 108 for storage. In some embodiments, the circuitry 202 may request the second distributed ledger 506B to directly transfer the fourth NFT 506C to the first distributed ledger 108 for storage. In such case, the second distributed ledger 506B may transmit the fourth NFT 506C to the first distributed ledger 108, based on the request received from the circuitry 202. Further, based on the storage of the third NFT 504A on the second distributed ledger 506B and the storage of the fourth NFT 506C on the first distributed ledger 108, the first digital product 116A may be exchanged with the third digital product 502B. In an embodiment, the first user (e.g., the user 126) may be different from the third user (e.g., the third user 502A). In another embodiment, the first user may be the same as the third user.

In case, different digital platforms operate use different distributed ledgers, an ability to exchange NFTs corresponding to digital products of the digital platforms, across the different distributed ledgers, may provide interoperability between the digital platforms. Thus, exchange of NFTs between the distributed ledgers associated with the different digital platforms may entail exchange of the digital products corresponding to the exchanged NFTs between the digital platforms.

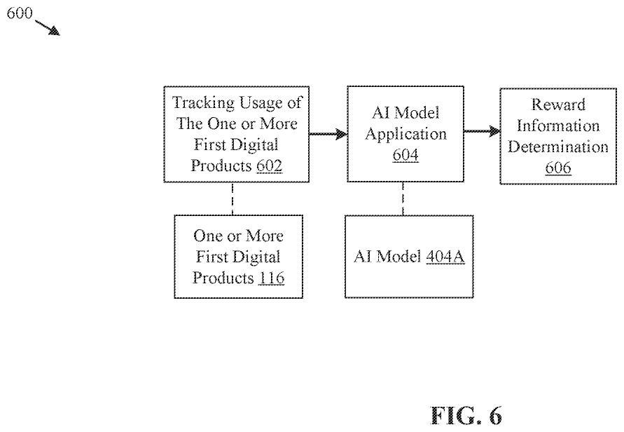

FIG. 6 is a diagram that illustrates an exemplary processing pipeline to determine reward information based on usage of one or more first digital products, in accordance with an embodiment of the disclosure. FIG. 6 is explained in conjunction with elements from FIG. 1, FIG. 2, FIG. 3, FIG. 4, and FIG. 5. With reference to FIG. 6, there is shown an exemplary processing pipeline 600 that illustrates exemplary operations from 602 to 606 to determine reward information based on usage of the one or more first digital products. The exemplary operations 602 to 606 may be executed by any computing system, for example, by the electronic device 102 of FIG. 1 or by the circuitry 202 of FIG. 2.

At 602, an operation to track a usage of the one or more first digital products may be executed. The circuitry 202 may be configured to track a usage of the one or more first digital products 116 by the first user (e.g., the user 126). For example, the first digital product 116A may correspond to a utility service (such as, a movie streaming service) associated with a first digital platform (of the set of digital platforms 118) such as, a utility application (for example, a video streaming application. The video streaming application may be an application programme that may be configured to stream videos, such as, movies, on electronic devices such as, a computer, a mobile phone, a smart television (TV), a gaming console, smart glasses, or a virtual reality (VR)/augmented reality (AR) headset, and the like. The use of the one or more first digital products 116 may be tracked by the circuitry 202. For example, when the user (such as, the user 126) uses the video streaming application to stream a set of videos, the circuitry 202 may track the usage of the video streaming application by the user 126. The usage may correspond to information such as, but not limited to, for what duration a video is streamed and how many times the video was streamed.

At 604, an operation for AI model application may be executed. The circuitry 202 may be configured apply the AI model 404A on the tracked usage and the on determined cost. The AI model 404A may be trained on a dataset that may include past tracked usage of a digital product for users other than the user 126. For example, the AI model 404A may be trained based on a pre-stored past tracked usage of the one or more first digital products 116 that may be received and stored over a time-period. The AI model 404A may determine a pattern associated with the tracked usage with respect to a time of day, date of year, and the like. For example, the AI model 404A may determine patterns such as, statistics related to a time of day and day of week or month or year when content of the one or more first digital product 116 was accessed and/or the determined cost associated with the one or more first digital products 116 for the user 126.

At 606, an operation for reward information determination may be executed. The circuitry 202 may be configured to determine reward information for the usage of the one or more first digital products by the first user (e.g., the user 126), based on the application of the AI model 404A. The circuitry 202 may be configured to determine the reward information based on the patterns determined by the AI model 404A. For example, the user (such as the user 126) may access certain digital content (such as, a promotional video) on a digital platform (such as, video streaming platform). Based on the application of the AI model 404A on the tracked usage and the on determined cost, the circuitry 202 may determine that the reward information (including, for example, a cash back reward, reward points, or royalty points) for first user (e.g., the user 126). In an embodiment, the reward may be an NFT, a digital currency, and the like, that may be allocated to the first user. For example, for consumption of a certain video content for more than 5 hours over a period of a week and a cost of over 10 US Dollars spent on purchase of a subscription for a video streaming service associated with the video content, the circuitry 202 may determine that the user 126 may be eligible for a cash back of 2 US Dollars or 200 reward points. The cash back reward or reward points provided to the user 126 may encourage the user 126 to continue to consume video content and also continue with the subscription of the video streaming service. Thus, provision of reward to the user 126 may help to enhance a revenue of the video streaming platform that hosts and offers the video content for consumption by subscribed users.

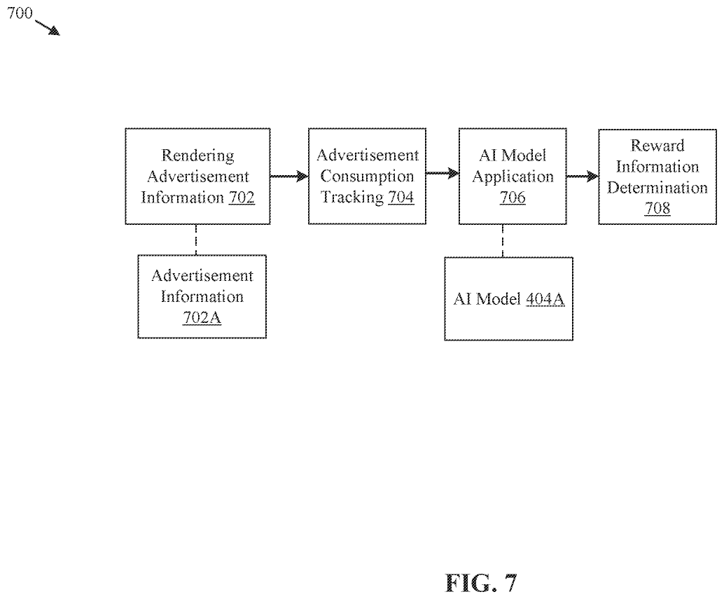

FIG. 7 is a diagram that illustrates an exemplary processing pipeline for reward information determination based on advertisement, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown an exemplary processing pipeline 700 that illustrates exemplary operations from 702 to 708 to determine reward information based on usage of the one or more first digital products. The exemplary operations 702 to 708 may be executed by any computing system, for example, by the electronic device 102 of FIG. 1 or by the circuitry 202 of FIG. 2.

At 702, an operation for advertisement information rendering may be executed. The circuitry 202 may be configured to render advertisement information 702A to be consumed by the first user (e.g., the user 126), based on the usage of the one or more first digital products 116. The advertisement information 702A may include advertisement content, such as, promotional videos from advertisement promoters. The advertisement may be rendered on the display device 210. The advertisement information 702A rendered on the display device 210 may be an interactive video that may require user input. The circuitry 202 may further provide an option to the user 126 to skip consumption of the advertisement or alternatively stream and consume the advertisement.

At 704, an operation for tracking of advertisement consumption may be executed. The circuitry 202 may be configured to track a consumption of the rendered advertisement information 702A, by the user 126. For example, the circuitry 202 may track information, such as, a number of times the advertisement was rendered, and whether the user (such as, the user 126) has streamed the whole video or skipped the video and the like. For example, the whole advertisement may have been rendered and streamed once, and the advertisement may have been skipped twice.

At 706, an operation for AI model application may be executed. The circuitry 202 may be configured to apply the AI model 404A on the tracked consumption of the rendered advertisement information 704A. The AI model 404A may be trained on a dataset that may include past advertisement information related to users other than the user 126. For example, the AI model 404A may be trained based on a pre stored past tracked consumption of advertisement that may be received and stored over a time-period. The AI model 404A may determine a pattern associated with the tracked usage (which may be determined based on, for example, a number of times the advertisement was streamed, or a number of times the advertisement was skipped, and the like).

At 708, an operation for reward information determination may be executed. The circuitry 202 may be configured to determine reward information associated with the rendered advertisement information 702A, based on the application of the AI model 404A. The circuitry 202 may be configured to determine reward information based on the patterns determined by the AI model 404A. For example, the user (such as, the user 126) may access an advertisement (such as, a promotional video) on a digital platform (such as, an OTT platform). In an example, based on the tracking of the rendered advertisement, the circuitry 202 may determine that the advertisement was streamed twice and skipped once. Accordingly, the circuitry 202 may determine a reward for user 126 as a cash back of 2 US Dollars or 200 reward points. In an embodiment, the reward may be an NFT, a digital currency, and the like, that may be allocated to the user 126. Thus, a user may be rewarded for consumption of advertisements on a digital platform during the consumption of a digital product through the digital platform. The reward may motivate and incentivize the user to consume the advertisements. The digital platform may earn revenue from advertisement promoters for the hosting of such advertisements. Further, the advertisement promoters may benefit from increased viewership and awareness of products and brand of the advertisement promoters.

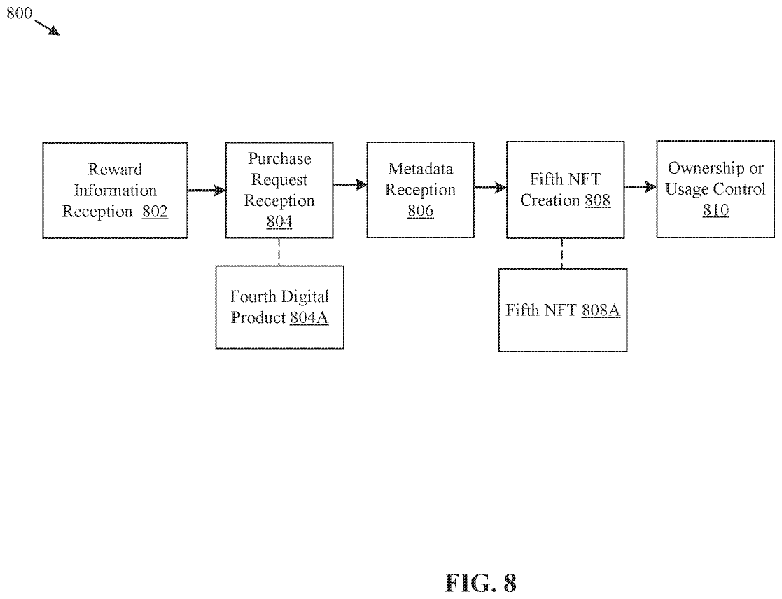

FIG. 8 is a diagram that illustrates an exemplary processing pipeline for purchase of a digital product based on reward information, in accordance with an embodiment of the disclosure. FIG. 7 is explained in conjunction with elements from FIG. 1, FIG. 2, FIG. 3, FIG. 4, FIG. 5, FIG. 6, and FIG. 7. With reference to FIG. 8, there is shown an exemplary processing pipeline 800 that illustrates exemplary operations from 802 to 810 for purchase of a digital product based on reward information. The exemplary operations 802 to 810 may be executed by any computing system, for example, by the electronic device 102 of FIG. 1 or by the circuitry 202 of FIG. 2.

At 802, an operation for reward information reception may be executed. The circuitry 202 may be configured to receive reward information for the one or more first digital products 116 associated with the first user (e.g., the user 126). The circuitry 202 may receive the reward information based on a completion of various tasks, such as, a consumption of advertisement content of the advertisement information 702A by the user 126. Based on completion of such tasks, the user (such as, the user 126) may be provided with a reward (which may be included in the reward information). In an example, on consumption of the advertisement content at least once, the user 126 may be granted a reward, such as, a cash back, reward points, loyalty points, discounts, offers, digital currency, or NFTs. The rewards earned by the user 126 may be used by the user 126 to make a purchase of a digital product from a digital platform.

At 804, an operation for purchase request reception may be executed. The circuitry 202 may be configured to receive a purchase request for a fourth digital product 804A based on the received reward information. The fourth digital product 804A may be selected from the one or more first digital product 116 or the one or more second digital products. A user input may be received through the I/O device 206 (such as, the display device 210). The received user input may be indicative of a purchase request of the fourth digital product 804A. For example, the user (such as the user 126) may accumulate a certain number (for example, 500) of reward points. The reward information may include the reward points. The reward points may be stored in the database 106 or the memory 204. In an embodiment, the reward information may be stored in a digital wallet. The digital wallet may be associated with the user (such as, the user 126). The reward points earned by the user may be used for purchase of the fourth digital product 804A, based on the received user input indicative of the purchase request.

At 806, an operation for metadata reception may be executed. The circuitry 202 may be configured to receive the metadata 110 associated with the fourth digital product 804A, based on the received reward information and the received purchase request. The circuitry 202 may be configured to receive the metadata 110. The metadata 110 associated with the fourth digital product 804A may be determined based on various factors, such as, but not limited to, the demand information 304A, the tracked usage information associated with the set of digital products 114, and the like. Data units associated with the metadata 110 may include the price information associated with the set of digital products 114, the duration of the subscription information associated with the set of digital products 114 and the like. The metadata 110 may be stored on the first distributed ledger 108. For example, based on the received reward information and the received purchase request, the circuitry 202 may determine that the fourth digital product 802A is requested by the user 126, against the reward (as per the reward information) earned by the user 126. Based on the determination that the fourth digital product 802A is requested by the user 126, the circuitry 202 may receive the metadata 110 associated with the fourth digital product 802A from the set of digital platforms 118.

At 808, an operation for fifth NFT creation may be executed. The circuitry 202 may be configured to create a fifth NFT (e.g., fifth NFT 808A) associated with the fourth digital product 802A based on a storage of the received metadata 110 to the first distributed ledger 108 associated with each of the set of digital platforms 118. The fifth NFT 808A may be created based on a storage of the received metadata 110 to a first distributed ledger (e.g., the first distributed ledger 108) associated with the set of digital platform 118. It may be appreciated that an NFT (e.g., the fifth NFT 808A) may be a non-interchangeable and non-fungible unit of data that may be stored on a distributed ledger (e.g., the first distributed ledger 108).

At 810, an operation for ownership or usage control operation may be executed. The circuitry 202 may be configured to control the ownership or the usage of the fourth digital product 802A, based on the created fifth NFT 808A. The fifth NFT 808A may be created based on the storage of the received metadata 110 to the first distributed ledger (e.g., the first distributed ledger 108) associated with the set of digital platform 118. It may be appreciated that an NFT (e.g., the fifth NFT 808A) may be a non-interchangeable and non-fungible unit of data that may be stored on a distributed ledger (e.g., the second distributed ledger 506B). The circuitry 202 may retrieve the fifth NFT 808A from the second distributed ledger 506B. For example, the circuitry 202 may request the second distributed ledger 506B for the fifth NFT 808A. The second distributed ledger 506B may verify whether the request of the circuitry 202 is legitimate or not and may further retrieve and transmit the retrieved fifth NFT 808A to the circuitry 202, based on the verification. The retrieved fifth NFT 808A may be associated with a user-right (e.g., the set of user-rights 122), such as, a modification right associated with the fourth digital product 804A. For example, based on the creation of the fifth NFT 808A, the ownership rights of the fourth digital product 804A may be controlled.

Thus, a user of a digital platform may earn rewards for a consumption of advertisement content when a digital product is accessed by the user through the digital platform. The rewards earned by the user may be redeemable to purchase another product (e.g., to buy a subscription of an OTT service for a certain time period). The ability to redeem rewards earned based on the consumption of the advertisement content through the digital platform may encourage the user to consume more advertisement content. This may enhance a click through rate associated with the advertisement content due to an enhanced reach. Further, the advertisement promoters may benefit from increased viewership and awareness of products and brand of the advertisement promoters. The digital platform may earn more revenue from advertisement promoters for the hosting of such advertisements.

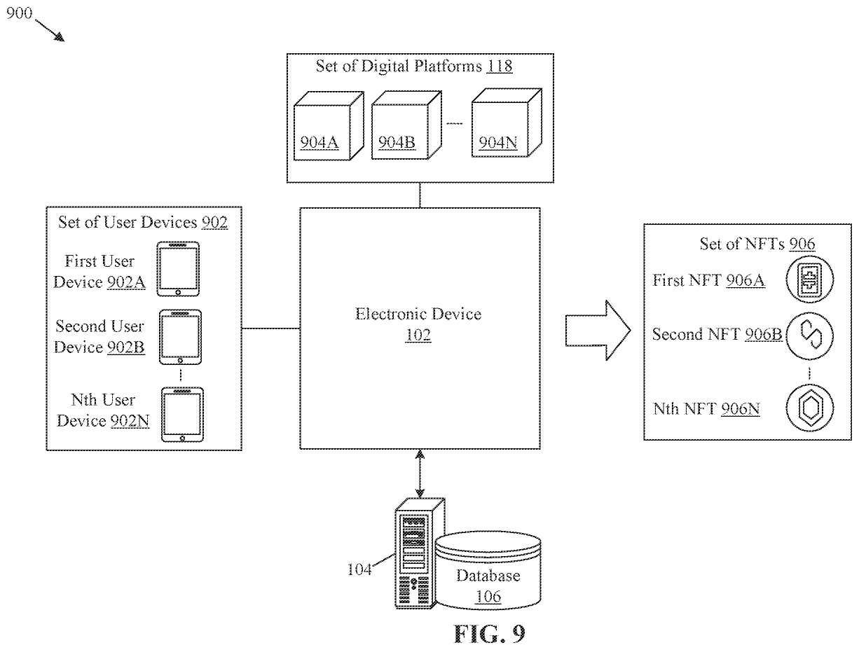

FIG. 9 is a diagram that illustrates an exemplary network architecture for NFT-based digital product subscription management, in accordance with an embodiment of the disclosure. FIG. 9 is explained in conjunction with elements from FIG. 1, FIG. 2, FIG. 3, FIG. 4, FIG. 5, FIG. 6, FIG. 7, and FIG. 8. With reference to FIG. 9, there is shown a network architecture 900 for NFT-based digital product subscription management.

The electronic device 102 may be associated with a set of user device 902. The set of user devices 902 may include ‘N’ number of user devices, such as, a first user device 902A, a second user device 902B, . . . and an Nth user device 902N. The user (such as, the user 126) may use an application program associated with the electronic device through the set of user devices 902. The set of user devices 902 may receive the user input 410A that may be used for the first subscription pack selection, and the like. Examples of the set of user devices 902 may include, but are not limited to, a computing device, a desktop, a personal computer, a laptop, a computer workstation, a tablet computing device, a smartphone, a cellular phone, a mobile phone, a wearable display, a utility device, a utility console, a smart television (TV), an augmented reality (AR)/virtual reality (VR)/mixed reality (MR) device, a head-mounted display (HMD) for utility, a heads-up display (HUD) for utility, smart glasses for utility, a mainframe machine, a server, and/or a consumer electronic (CE) device.

The set of digital platforms 118 may include ‘N’ number of the set of digital platforms, such as, a first digital platform 904A, a second digital platform 904B, . . . and an Nth digital platform 904N. Each of the set of digital platforms 118 may include logic, circuitry, and interfaces, and/or code that may be configured to host a service or an application programming interface (API) through which a user (e.g., the user 126) may consume or access the set digital products 114. For example, digital platforms may correspond to one or more platforms that may provide an online portal where exchange of content (created by generators for the digital products, services, and information) and considerations (e.g., a monetary value or a subscription fee) for the content (provided by end-users) may take place. In other cases, the digital platform may also include games from multiple companies.

In an embodiment, each of the set of digital platforms 118 may be associated with the first distributed ledger 108 and the set of digital products 114. In an embodiment, the set of digital platforms 118 may be implemented or hosted on the server 104. Additionally, or alternatively, the set of digital platforms 118 may be implemented or hosted on the electronic device 102. In such case, information related to the set of digital platforms 118 and the set of digital products 114 may be stored on a memory (e.g., the memory 204 of FIG. 2) of the electronic device 102 or the database 106. The set of NFTs 906 may include ‘N’ number of NFTs, such as, a first NFT 906A, a second NFT 906B, . . . an Nth NFT 906N. Each of the set of NFTs 906 may be associated with the set of user-rights 122.

The N number of user devices, digital products, and NFTs shown in FIG. 9 are presented merely as an example. The set of user devices 902, the set of digital products 904, and the set of NFTs 906 may include only one or more than N user devices, digital products, and NFTs, respectively, without deviation from the scope of the disclosure. For the sake of brevity, only N user devices, digital products, and NFTs have been shown in FIG. 9. However, in some embodiments, there may be more than N user devices, digital products, and NFTs, without limiting the scope of the disclosure.

In an embodiment, each of the set of digital platforms 118 may be interoperable. For example, digital products hosted and available on the first digital platform 904A may be migrated to the second digital platform 904B and hosted on the second digital platform 904B. Each of the set of NFTs 906 may be associated with the set of digital platforms 118. In an example, the set of user devices 902 may transmit a request to the electronic device 102 for creation of NFTs, retrieval of NFTs, assignment of the set of user-rights 122, modification of the set of user-rights, and the like.

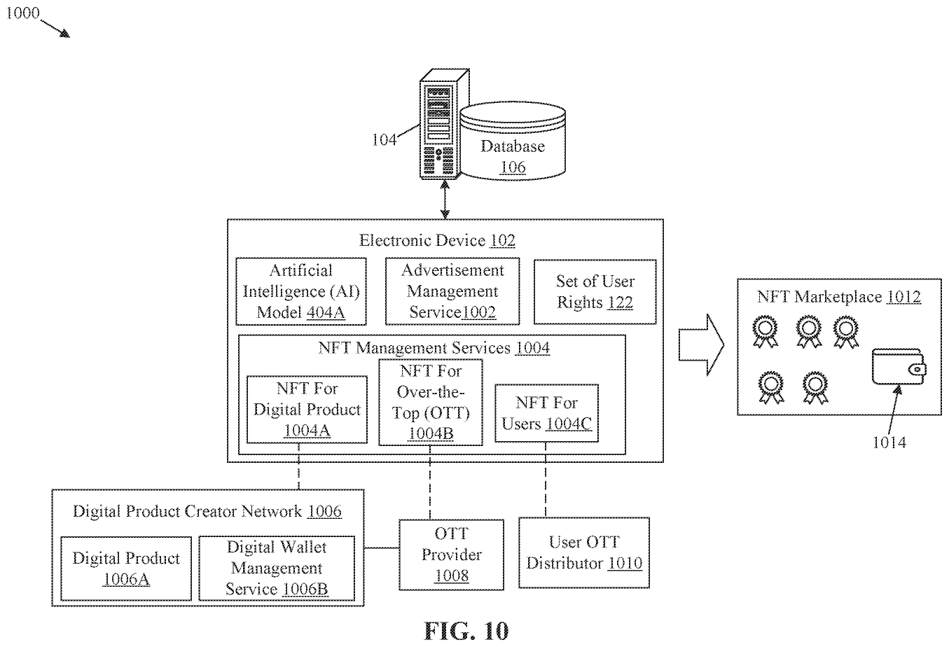

FIG. 10 is a diagram that illustrates an exemplary block diagram for NFT-based digital product subscription management, in accordance with an embodiment of the disclosure. FIG. 10 is explained in conjunction with elements from FIG. 1, FIG. 2, FIG. 3, FIG. 4, FIG. 5, FIG. 6, FIG. 7, FIG. 8, and FIG. 9. With reference to FIG. 10, there is shown a block diagram 1000 that illustrates NFT-based digital product subscription management.

In FIG. 10, there is shown the electronic device 102, which may be communicatively coupled to the server 104 (that may host the database 106) and a device associated with an NFT marketplace 1012. The electronic device 102 may include the AI model 404A, an advertisement management service 1002, the set of user-rights 122, NFT management services 1004 (including an NFT for digital product 1004A, an NFT for Over-The-Top (OTT) 1004B, an NFT for users 1004C). The NFT for digital product 1004A may be associated with a digital product creator network 1006 including a digital product 1006A and a digital wallet management service 1006B. An OTT provider 1008 may be associated with the digital product creator network 1006 and the NFT for OTT 1004B. A user OTT distributor 1010 may be associated with the NFT for users 1004C. Further, the NFT marketplace 1012 may be associated with a digital wallet 1014.

The advertisement management service 1002 may be a logic, circuitry, interface, and/or code implemented by the electronic device 102 that may be configured to manage presentation and tracking of advertisements associated with the set of digital platforms 118. The advertisement management service 1002 may render advertisements (related to the advertisement information 702A) to be consumed by the user 126, based on the one or more first digital products 116. The advertisement information 702A may include promotional videos, from advertisement promoters. The advertisement information 702A may be rendered on the display device 210. In certain cases, the advertisement information 702A rendered on the display device 210 may be an interactive video that require user input 410A.

The advertisement management service 1002 may track a consumption of the rendered advertisement information 702A by the user 126. For example, statistics such as, a number of times the advertisement was rendered on the display device 210, whether the user 126 consumed the whole video or skipped the video, and the like, may be tracked. In an example, based on the tracking of the rendered advertisement, the circuitry 202 may determine that the advertisement was streamed twice and skipped once.

The circuitry 202 may be configured to apply the AI model 404A on the tracked consumption of the rendered advertisement information 704A. The AI model 404A may be trained on a dataset that may include past advertisement information related to users other than the user 126. For example, the AI model 404A may be trained based on a pre-stored past tracked consumption of advertisements that may be received and stored over a time-period. The AI model 404A may determine a pattern associated with the tracked usage (which may be determined based on, for example, a number of times the advertisement was streamed, or a number of times the advertisement was skipped, and the like).

The NFT management services 1004 a logic, circuitry, interface, and/or code implemented by the electronic device 102 that may be configured to manage NFTs (such as, the NFT for digital product 1004A, the NFT for OTT 1004B, and the NFT for users 1004C) across different digital platforms of the set of digital platforms 118. The NFT for digital product 1004A may be associated with a digital product creator network 1006. The digital product creator network 1006 may include a set of creators that may be generate a set of digital products, such as, the digital product 1006A. In an embodiment, the digital product 1006A may correspond to a plurality of different digital products. Further, the digital product creator network 1006 may include digital wallet management service 1006B. The digital wallet management service 1006B may store the NFT for digital product 1004A (for a certain time period).

In an embodiment the digital product creator network 1006 may be associated with the OTT providers 1008. The OTT providers 1008 may include a user or an organization that may facilitate a delivery of the digital product 1006A over the communication network 124. The OTT providers 1008 may be associated with NFT for OTT 1004B. Further, the NFT for users 1004C may be associated with the user OTT distributor 1010. The user OTT distributor 1010 may include individual OTT users that generate digital product 1006A and directly stream to other individual users either using a peer-to-peer streaming application or a centralized streaming application. Further, the transactions of the NFTs (such as, the NFT for digital product 1004A, the NFT for OTT 1004B, and the NFT for users 1004C) may be executed on the NFT marketplace 1012. The NFT marketplace 1012 may facilitate the user (such as, the user 126) to purchase or sell a digital product for a limited time period or for remainder time period of the subscription. The NFT marketplace 1012 may allow transactions with the digital wallet 1014. The digital wallet 1014 may help the user (such as the user 126) to store any or a combination of NFTs or reward points.

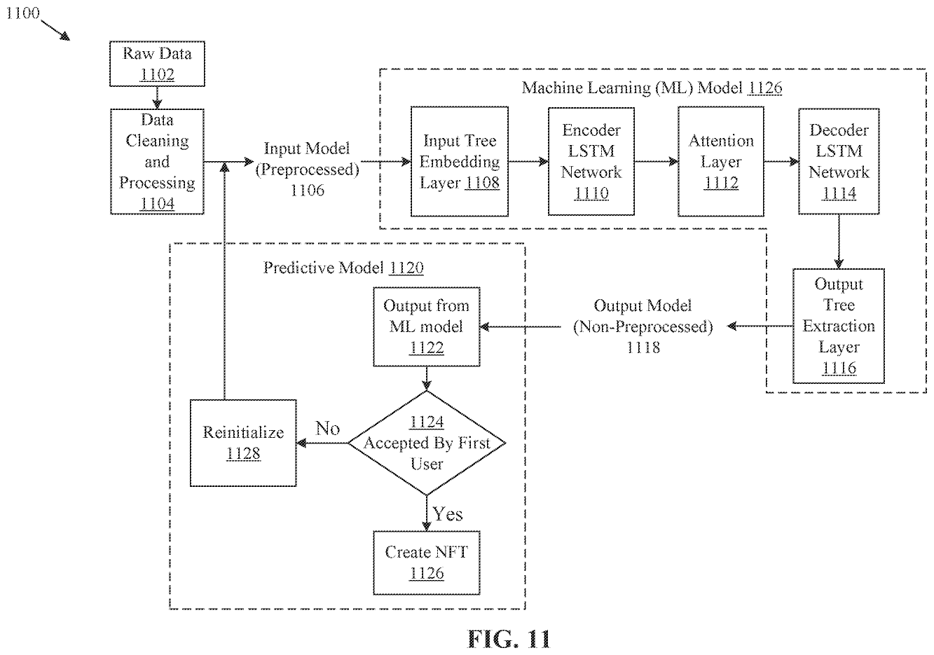

FIG. 11 is a diagram that illustrates an exemplary block diagram for an AI model, in accordance with an embodiment of the disclosure. FIG. 11 is explained in conjunction with elements from FIG. 1, FIG. 2, FIG. 3, FIG. 4, FIG. 5, FIG. 6, FIG. 7, FIG. 8, FIG. 9, and FIG. 10. With reference to FIG. 11, there is shown a block diagram 1100 that illustrates NFT-based digital product subscription management.

The AI model 404A may be used to determine the cost and the metadata 110 associated with the one or more first digital products 116. The AI model 404A may be implemented using the circuitry 202. At 1102, raw data may be received. The circuitry 202 may receive the raw data from various sources such as the server 104, the database 106, the memory 204 and other sources. The received raw data may correspond to historical subscription information of users of the set of digital platforms 118.

At 1104, the received raw data may be cleaned and processed. The circuitry 202 may execute a data cleaning and processing operation on the received raw data. For example, for the data cleaning, the circuitry 202 may determine missing data, data with incorrect format, duplicate data, or corrupted data. The circuitry 202 may impute the missing data, correct the format of the incorrectly formatted data, deduplicate the raw data, and remove the corrupted data. After the data cleaning operation is executed, the circuitry 202 may execute pre-processing of the cleaned raw data using techniques such as, exploratory data analytics (EDA). The EDA technique may be used to determine trends and insights in data from statistical analysis of the data.

At 1106, the cleaned and processed data is fed to an input model (e.g., a neural network model). The circuitry 202 may apply the input model on the cleaned and processed data. The cleaned and processed data may be fed to the input model to apply the input model on the cleaned and processed data.

At 1108, the pre-processed data is fed to an input tree embedding layer 1108. The circuitry 202 may feed the pre-processed data from the input model (1106) to the input tree embedding layer 1108 of a machine learning (ML) model 1126. The input tree embedding layer 1108 may be used to create word vectors for incoming words. The input tree embedding layer 1108 may lie between the input model 1106 and a Long Short-Term Memory (LSTM) layer (of an encoder LSTM network 1110). The output of the input tree embedding layer 1108 may be the input to the LSTM layer. Weights for the input tree embedding layer 1108 can either be initialized with random values or may be initialized with third-party word embeddings such as word2vec, GloVe or fasttext (or others). The weights may be optionally fine-tuned during training. Use of third-party embeddings to build word vectors is as a form of transfer learning, which may involve a transfer of semantic information between words that may be learned during the embedding process. An embedding table may map long, sparse, binary vectors into shorter, dense, continuous vectors. For example, a text is received as a sequence of American Standard Code for Information Interchange (ASCII) characters. There may be 256 possible values of an ASCII character, and hence, each character may be represented as a binary vector with 256 dimensions. For example, the value for the character “a” may be a vector having 255 dimensions corresponding to zeros, and the 97th dimension corresponding to a “1”, while the value for the character “b” may be a vector of 255 zeros with a “1” at the 98th dimension. This is referred to as a “one hot” encoding technique. Different values may correspond to different vectors.

At 1110, the encoder LSTM network 1110 may receive an input from the input tree embedding layer 1108. The circuitry 202 may feed output of the input tree embedding layer 1108 to the encoder LSTM layer. The encoder LSTM layer may include a stack of a plurality of recurrent units (such as, LSTM or gated recurrent unit (GRU) cells for better performance). Each unit of the plurality of recurrent units may receive a single element of an input sequence, accumulate information for the received element and propagate the received element forward. For example, in a question-answering problem, the input sequence may be a collection of all words from the question. Further, an encoder layer of the encoder LSTM network 1110 may comprise an encoder vector. The encoder vector may be a final hidden state that may be generated by the encoder LSTM network 1110. The encoder vector may be used to accumulate information associated with all input elements to help a decoder generate accurate predictions. In an embodiment, the encoder vector may act as an initial hidden state of a decoder part of an ML model 1126.

At 1112, the output from the encoder LSTM network 1110 may be fed to an attention layer as an input. The circuitry 202 may feed an output of the Encoder LSTM network 1110 to the attention layer 1112. The attention layer 1112 may correspond to a deep learning layer that may be used to assign a weight to a set of relevant input elements based on a relative importance of each input element. The attention layer may further correspond to a weighted mean reduction. For example, the circuitry 202 may compute a mean weight of each element contributing to a mean value and reduction occurs based on the weight values. The attention layer 1112 may comprise three inputs that may include a query, values, and keys. The reduction may occur over the values. Therefore, if the values are rank “3”, output will be rank “2”. The query may be ranked one less rank than the keys. The keys may be ranked the same rank as the values. The keys and query may determine how to weight the values according to attention mechanism of the attention layer.

In an example, for a sentence, such as, “The sleepy child reads a book”, the words in the sentence may correspond to the keys. If the words correspond to embeddings, then keys may be ranked “2”. For example, the word “sleepy” may be represented by an embedding vector of length 2, where embedding values may be trained or taken from a standard language embedding. The query may include an element from the keys, like the word “book.” A point of attention may be determined based on parts of the sentence, that the query should be influenced by. For example, “Book” may have strong attention on “child” and “reads,” and, probably not to “sleepy.”. The output from the attention layer 1112 may be a reduction over the values where each element of values may be weighted by the attention between the query and the key. Therefore, there may be one key and one value for each element in the sentence.

At 1114, the output from the attention layer 1112 may be fed to a decoder LSTM network as an input. The circuitry 202 may feed output of the attention layer 1112 to the decoder LSTM network 1114. The decoder LSTM network 1114 may comprise a stack of several recurrent units, where each recurrent unit may predict an output after a predefined time-period. Each recurrent unit may accept a hidden state of the previous recurrent unit and produce an output as well as its own hidden state. In an example, in question-answering problem, an output sequence may have a collection of all words from the answer. It may be appreciated that previous hidden state may be used to compute next hidden state.

At 1116, an output may be computed using the hidden state at the current time step together with the respective weight. The circuitry 202 may be used to create a probability vector that may be used to determine a final output (for example, a word in a question-answering problem). It may be appreciated that the AI model 404A can map sequences of different lengths with each other. Further, inputs and outputs may not be correlated and have different length. For example, an output tree extraction layer 1116 of the ML model 1126 may provide an output model 1118 (which may correspond to non-preprocessed data) as an output of the ML model 1126.

At 1118, an output from the ML model 1126 may be fed to a predictive model 1120. The circuitry 202 may be configured to feed the output of the ML model 1126 to the predictive model 1120. The output of the ML model 1126 may be a finite value that may correspond to a cost associated with a product for which an NFT (such as, the one or more first NFTs 112) is to be created. For example, based on an application of the AI model 404A on the received raw data 1102, the cost associated with the product corresponding to the NFT may be determined.

At 1120, the predictive model 1120 may be configured to perform a regression tree analysis on the output from the ML model 1126 to determine a final value of the one or more first NFTs 112. A regression tree may correspond to a decision tree in which target variables may take continuous values instead of class labels in leaf nodes of the regression tree. The regression tree may correspond to a regression or classification model, which may be represented in the form of a tree structure. The regression tree may have root node(s), decision nodes, and leaf nodes. In an example, as illustrated in FIG. 11, at block 1122, the output from the ML model 1126 may be represented as a root node of the regression tree. At decision box 1124, a decision of the user 126 for an acceptance of a prediction result (e.g., a cost of the product) of the prediction model 1120 may be represented as a decision node of the regression tree. At block 1126, an operation for creation of an NFT corresponding to the product may be executed. The operation for creation of the NFT may be represented as a first leaf node of the regression tree. Further, at block 1128, the process of the cost determination may be re-iterated and parameters of the ML model 1126 may be re-initialized. The re-iteration and re-initialization of the process of the cost determination may be represented as a second leaf node of the regression tree.

At 1122, the output from the ML model 1126 may be rendered on the display device 210. The circuitry 202 may control the display device 210 to render the output from the ML model 1126 for acceptance by the first user (such as, the user 126). The user 126 may accept or reject the output.

At 1124, a user input indicative of an acceptance of the rendered output may be received. Based on the acceptance, the circuitry 202 may create a NFT (for example, the one or more first NFTs 112) with a cost value corresponding to the rendered output accepted by the user 126. In an embodiment, if the user input may correspond to rejection of the rendered NFT value, the circuitry 202 may re-iterate and re-initialize the process of the cost determination (at 1128) and then pass the control to 1106.

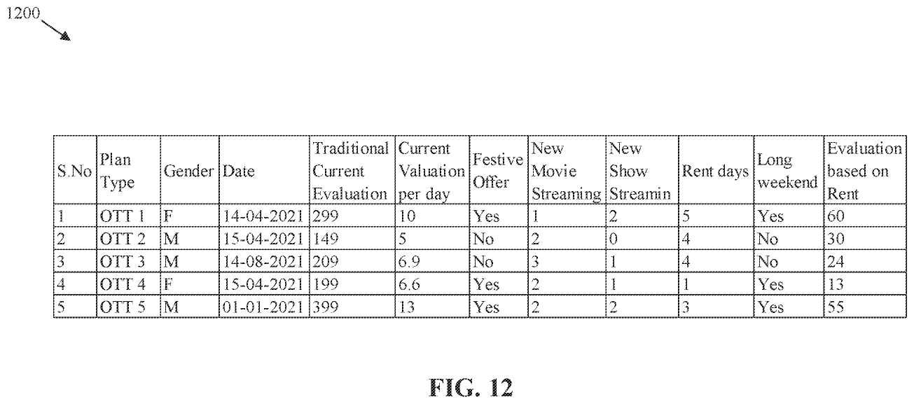

FIG. 12 is a table that illustrates an exemplary data output from the AI model for NFT-based digital product subscription management, in accordance with an embodiment of the disclosure. FIG. 12 is explained in conjunction with elements from FIG. 1, FIG. 2, FIG. 3, FIG. 4, FIG. 5, FIG. 6, FIG. 7, FIG. 8, FIG. 9, FIG. 10, and FIG. 11. With reference to FIG. 12, there is shown a table 1200 that illustrates exemplary data that may be output from the AI model 404A.

For example, the table 1200 of FIG. 12 may comprise a plan type (such as, a subscription type) that may correspond to the one or more first digital products 116 (such as, movie streaming service on a digital platform). The table 1200 may further comprise gender (such as, Male or Female) of user (such as, the user 126). The table 1200 may further comprise a date of initiation of current subscription plan. The table 1200 may further comprise a traditional current valuation, that may correspond to valuation of the subscription pack for a remainder of a time-period of the subscription. The table 1200 may further comprise a current valuation per day, that may correspond to value of the subscription pack in normal or traditional scenario. The table 1200 may further comprise a festive offer (such as, advertisement information 702A), that may correspond to any festive offer that may be available during the remainder time-period of subscription. The table 1200 may further comprise information such as, whether there is any new movie or show that may be streaming on the one or more first digital products 116 (such as, a movie streaming service on a digital platform). It may be appreciated that the demand information 304A for the digital product of the digital platform may be higher if there are any new movie or show that may be streaming on the digital platform. In an embodiment, the more the number of new shows or movies that may be streaming on the digital platform, the more will be the demand information 304A for the digital platform. The table 1200 may further comprise information such as rent days, that may correspond to a number of days that the user (such as, user 126) intends to create a subscription pack for sale to another user. The table 1200 may further comprise information such as, whether there is a long weekend, that may correspond to any federal or state holidays that may fall on Friday or Monday that may be available during the remainder time-period of subscription that the user 126 intends to sell. Further, the table 1200 comprises an evaluation based on rent, that may correspond to a value of a subscription pack for the rent days. The value of ‘evaluation based on rent’ may be determined based on the rent days and the demand information 304A.

It should be noted that the values in the table 1200 of FIG. 12 are for exemplary purposes and should not be construed to limit the scope of the disclosure.

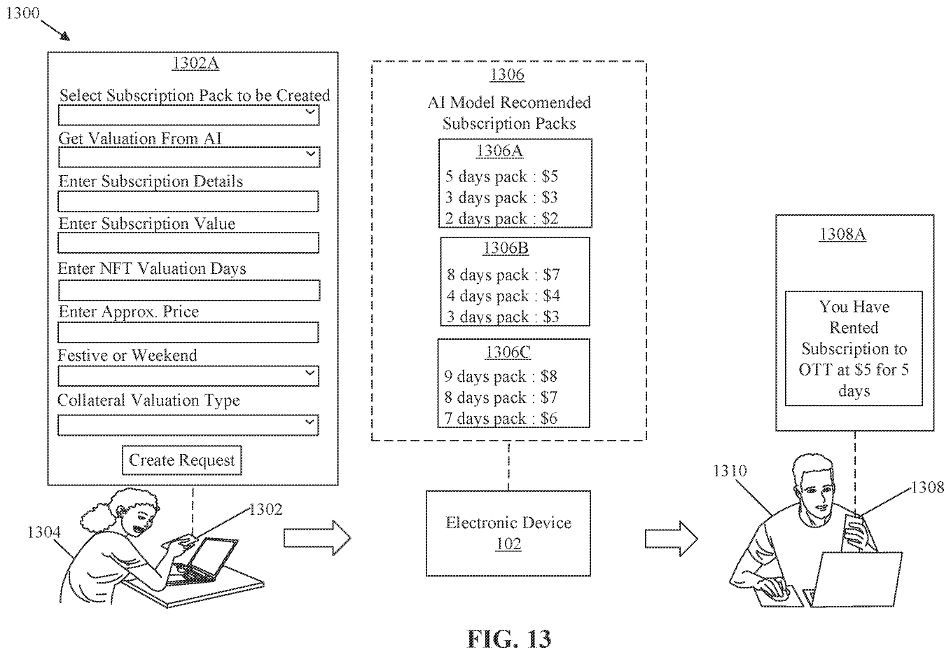

FIG. 13 is a diagram that illustrates an exemplary scenario for NFT-based digital product subscription management, in accordance with an embodiment of the disclosure. FIG. 13 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, and FIG. 12. With reference to FIG. 13, there is shown an exemplary scenario 1300 that illustrates NFT-based digital product subscription management.

In an example, as illustrated in the scenario 1300, a user 1304 may intend to sell a part of subscription to a digital product or a digital platform for a remainder time-period of subscription of the user 1304. For example, the user (such as, the user 1304) may have a subscription for the digital platform (such as, a movie streaming platform) for 12 months. The user 1304 may leave for vacation for 10 days and may not be available to access the digital platform. Therefore, the user 1304 may create a request to sell or lease out the subscription of the digital platform for the period of 10 days corresponding to the vacation, using a user device 1302. The request may include details, such as, the information provided in table 1200 of FIG. 12. Details of the request may be rendered on a graphical user interface (GUI) 1302A of the user device 1302. After all the details are provided through the GUI 1302A, the circuitry 202 of the electronic device 102 may receive the user input 410A for creation of the request.

The electronic device 102 may apply the AI model 404A on the details in the received request and determine AI model recommended subscription packs 1306. For example, the AI model recommended subscription packs 1306 may include a set of three packs (such as, packs 1306A, 1306B, and 1306C). In an embodiment, the electronic device 102 may generate less than three subscription packs or more than three subscription packs, without deviation from the scope of the disclosure. The circuitry 202 may receive the user input 410A, which may be indicative of a user selection of at least one of the AI model recommended subscription packs 1306.

Based on the user selection in the received user input 410A, the selected at least one of the AI model recommended subscription packs 1306 may be rendered on the GUI 1308A of a user device 1308 of a user 1310. The user 1310 may provide an input indicative of a selection a subscription pack, and further make payment to complete purchase of the selected subscription pack. Further, based on completion of the purchase, the GUI 1308A may render a message, such as, ‘You have rented subscription to OTT at $5 for 5 days’.

It should be noted that the scenario 1300 of FIG. 13 is for exemplary purposes and should not be construed to limit the scope of the disclosure.

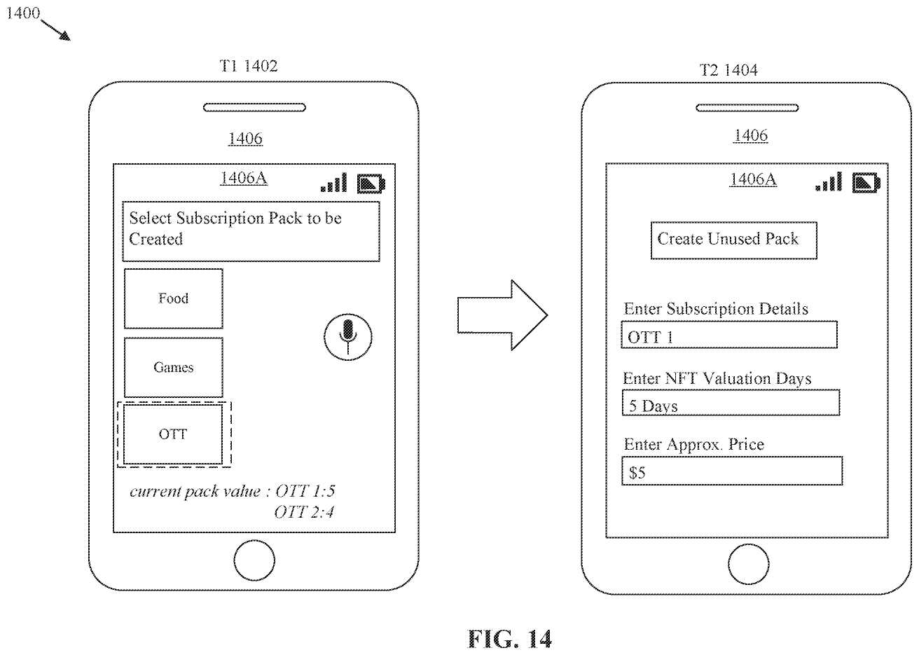

FIG. 14 is a diagram that illustrates an exemplary scenario for subscription pack creation, in accordance with an embodiment of the disclosure. FIG. 14 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, and FIG. 13. With reference to FIG. 14, there is shown an exemplary scenario 1400 that illustrates subscription pack creation.

In an example, as illustrated, at a first time instance T1 1402, a GUI 1406A of a user device 1406 may display a message such as, ‘Select subscription pack to be created’. For example, as illustrated, a user input may be received, and an “OTT” option may be selected from subscription pack options, such as, “Food”, “Games”, and “OTT”. Based on the selection, the GUI 1406A may display popular subscription packs for “OTT” and corresponding values or costs. In an embodiment, the user input may be received as a voice command, that may correspond to the selection of the “OTT” option.

At a second time instance T2 1404 after the first time instance T1 1402, based on the user selection of the subscription pack option “OTT”, a user input may be received for selection of a digital platform (such as, a first OTT platform, e.g., an “OTT 1”) for which the subscription pack is to be created. Further, the user input may be received to provide an NFT valuation days (such as, 5 days) that corresponds to a time period of validity of the subscription pack to be created, and approximate price (for example, $5). Further, the user input may be received for selection of a button, such as, a button for ‘Create Unused Pack’ displayed in the GUI 1406A on the user device 1406. Based on the selection of the button and the user inputs received at the second time instance T2 1404, an unused pack may be created for a user.

It should be noted that the scenario 1400 of FIG. 14 is for exemplary purposes and should not be construed to limit the scope of the disclosure.

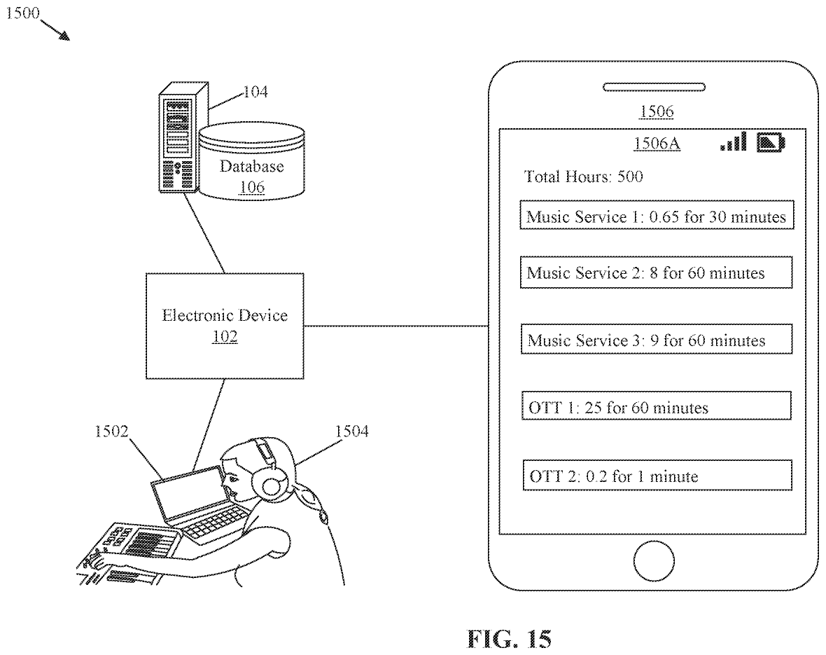

FIG. 15 is a diagram that illustrates an exemplary scenario of pay per use of digital product, in accordance with an embodiment of the disclosure. FIG. 15 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14. With reference to FIG. 15, there is shown an exemplary scenario 1500 that illustrates pay per use of digital products.

In an example, as illustrated, a user (such as, a musician 1504) may create a music composition, but due to lack of resources may not be able to promote or advertise the composition. The musician 1504 may not be able to get a proper value for the composition, and further the composition of the musician 1504 might go unnoticed. The electronic device 102 of the present disclosure may provide an option to the musician 1504 to upload (or store) the composition using a user device 1502 on the memory 204 of the electronic device 102, the server 104, or the database 106.

The electronic device 102 may stream the composition of the musician 1504 on the set of digital platforms 118 (such as, music streaming platforms, video streaming platforms, and movie streaming platforms). It may be appreciated that since the composition is available on multiple digital platforms, the musician 1504 may be able to reach a larger audience for the composition. The electronic device 102 may provide a ‘pay-per-use’ option, that may correspond to a payment model that charges a consumer on the basis of resource (e.g., music) usage (i.e., consumption), such as, number of playbacks, time period of playback, number of downloads, and the like.

The electronic device 102 may control a user device 1506 to render information pertaining to the set digital platforms 118 on a GUI 1506A of the user device 1506. In an example, the user 126 may purchase subscription to the set of digital platforms 118 for a time duration (for example, 500 Hours). Each digital platform, of the plurality of digital platforms 118, may use a different rate that may be charged to the user 126. For example, a first digital platform for music streaming may charge at a rate of 0.65 $ for 30 minutes, while a second digital platform for streaming music may charge at a rate of 8 $ for 60 minutes and the like.

It should be noted that the scenario 1500 is for exemplary purposes and should not be construed to limit the scope of the disclosure.

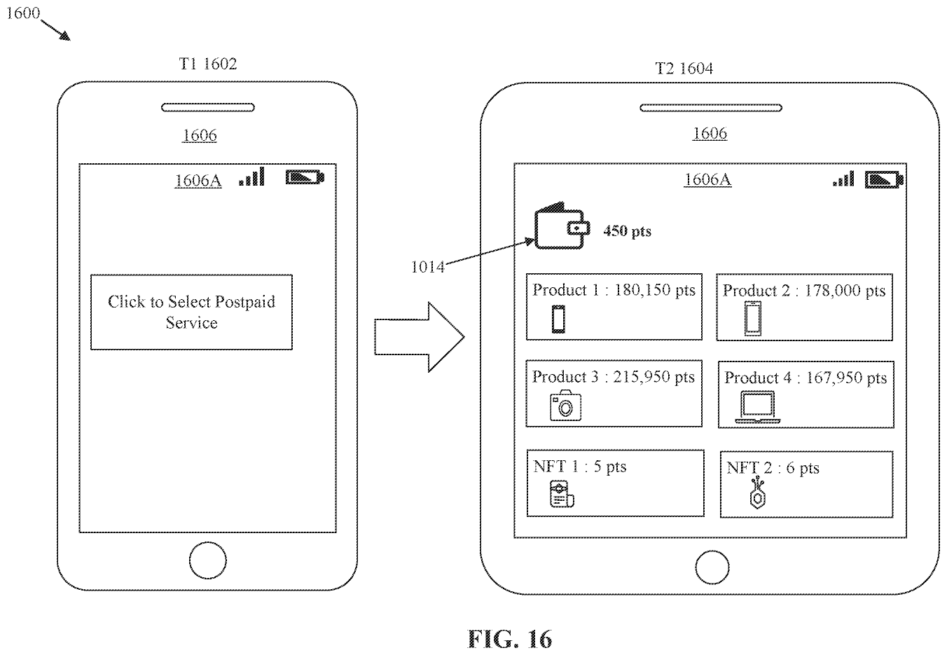

FIG. 16 is a diagram that illustrates an exemplary scenario of a digital wallet to make a purchase, in accordance with an embodiment of the disclosure. FIG. 16 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, and FIG. 15. With reference to FIG. 16, there is shown an exemplary scenario 1600 that illustrates digital wallet to make a purchase.

At a first time instance T1 1602, the circuitry 202 may control a user device 1606 to display a GUI 1606A, which may include an option for the user 126 to select a postpaid service (e.g., through a button indicative of a text such as, ‘Click to Select Postpaid Service’). The postpaid service may correspond to a service where users may use services prior to a payment for the services, for example, a recurrent payment of an amount at the end of each monthly bill cycle.

At a second time instance T2 1604, the GUI 1606A may display information related to the digital wallet 1014. The digital wallet 1014 may correspond to information related to a cash back, points, or credits that the user 126 may have accumulated. The user 126 may earn the cash back, points, or credits based on streaming of the advertisement information 702A, and the like. The cash back, points, or credits accumulated in the digital wallet 1014 may be used to purchase products (such as, a Product “1”, a Product “2”, a Product “3”, or a Product “4”) and/or NFTs (such as, NFT1 or NFT2) in exchange for the cashback, points, or credits.

It should be noted that the scenario 1600 of FIG. 16 is for exemplary purpose and should not be construed to limit the scope of the disclosure.

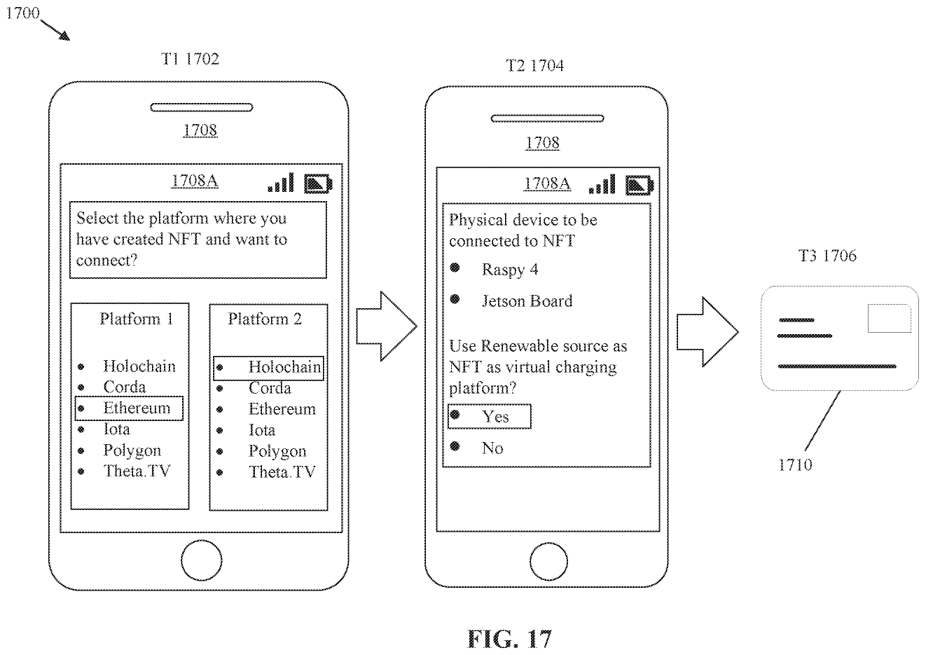

FIG. 17 is a diagram that illustrates an exemplary scenario of interoperability of a virtual NFT and a physical NFT, in accordance with an embodiment of the disclosure. FIG. 17 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, and FIG. 17. With reference to FIG. 17, there is shown an exemplary scenario 1700 that illustrates virtual NFT and physical NFT interoperability.

At a first time instance T1 1702, the circuitry 202 may be configured to control a user device 1708 to display a GUI 1708A including an option for the user 126 to select a platform associated with a created NFT which is to be connected. For example, the GUI 1708A may include a button with a text, such as, ‘Select the platform where you have created NFT and want to connect?’. The GUI 1708A may further provide options of NFTs (such as, “Holochain”, “Corda”, “Ethereum”, “lota”, “Polygon”, “Theta.tv”, and the like) on a Platform “1” and a Platform “2”. In an example, a user input may be received to select ‘Ethereum’ on Platform “1” and ‘Holochain’ on Platform “2”.

At a second time instance T2 1704, the circuitry 202 may be configured to control the user device 1708 to display via the GUI 1708A, an option to select a physical device to be connected to an NFT. The GUI 1708A may further provide an option to use a renewable source as an NFT for a virtual charging platform. Based on the displayed options, a user input may be received. For example, the received user input may indicate a selection of an input ‘Yes’ for the use of renewable source option.

At a third time instance T3 1706, based on the user input indicative of a selection of ‘Yes’ for the use of renewable source option, the circuitry 202 may link a first NFT-based Internet-of-Things (IoT) card 1710 with the NFT (such as, the one or more first NFTs 112). The circuitry 202 may be further configured to virtually charge the first NFT-based Internet-of-Things (IoT) card 1710, based on the control of the ownership or the usage of the second digital product 116B. For example, in case, the user 126 has a subscription of a certain digital product for a month, an NFT may be created for the product and associated with a user profile of the user 126. The created NFT may be stored on the first distributed ledger 108. The NFT may correspond to metadata such as, product details, subscription details, and a cost associated with the digital product. The ownership or usage of the digital product by the user 126 may be controlled based on the created NFT. Further, if the created NFT is linked to an NFT-based loT card, the linked NFT-based loT card may be virtually charged based on the control of the ownership or the usage of the digital product using the created NFT. In an embodiment, a second NFT-based loT card may be charged based on the virtually charged first NFT-based loT card 1710. For example, in case, the second NFT-based loT card is brought in a physical proximity of the first NFT-based loT card 1710, the second NFT-based loT card may be virtually charged, for example, based on indictive charging.

It should be noted that the scenario 1700 of FIG. 17 is for exemplary purposes and should not be construed to limit the scope of the disclosure.

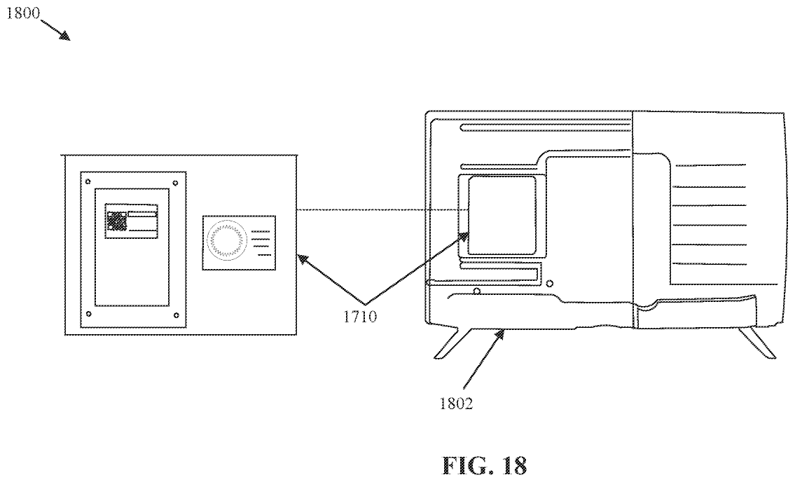

FIG. 18 is a diagram that illustrates an exemplary scenario of an interoperability between a virtual NFT and a physical NFT, in accordance with an embodiment of the disclosure. FIG. 18 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, and FIG. 17. With reference to FIG. 18, there is shown an exemplary scenario 1800 that illustrates physical NFT operation.

The virtually charged first NFT-based loT card 1710 may be a solar powered device. The virtually charged first NFT-based loT card 1710 may be used to provide electrical power to a consumer electric device 1802. The consumer electric device 1802 may include but not limited only to a computer, a television, a laptop, and the like.

It should be noted that the scenario 1800 of FIG. 18 is for exemplary purposes and should not be construed to limit the scope of the disclosure.

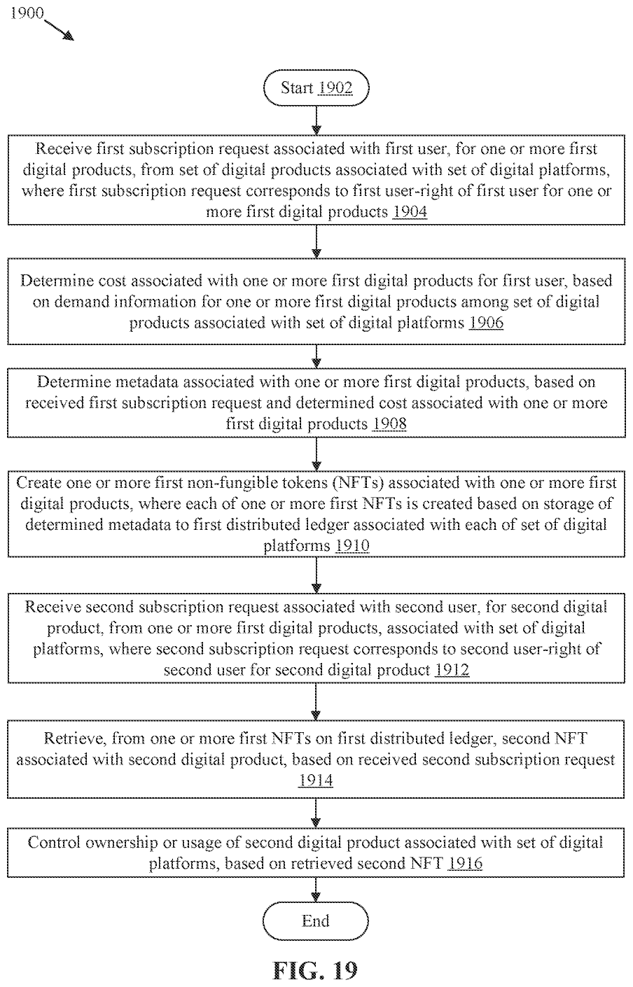

FIG. 19 is a flowchart that illustrates operations of an exemplary method for non-fungible token (NFT)-based digital product subscription management, in accordance with an embodiment of the disclosure. FIG. 19 is described in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, and FIG. 18. With reference to FIG. 19, there is shown a flowchart 1900. The flowchart 1900 may include operations from 1902 to 1916 and may be implemented by the electronic device 102 of FIG. 1 or by the circuitry 202 of FIG. 2. The flowchart 1900 may start at 1902 and proceed to 1904.

At 1904, the first subscription request associated with a first user (for example, the user 126) may be received for the one or more first digital products 116, from the set of digital products 114 associated with the set of digital platforms 118, wherein the first subscription request may correspond to the first user-right 126A of the first user (e.g., the user 126) for the one or more first digital products 116. In an embodiment, the circuitry 202 may be configured to receive the first subscription request associated with the first user (e.g., the user 126) for the one or more first digital products 116, from the set of digital products 114 associated with the set of digital platforms 118. The first subscription request may correspond to the first user-right 126A of the first user (e.g., the user 126) for the one or more first digital products 116. The reception the first subscription request is described further, for example, in FIG. 3 (at 302).

At 1906, the cost associated with the one or more first digital products 116 may be determined, based on the demand information for the one or more first digital products 116 among the set of digital products 114 associated with the set of digital platforms 118. In an embodiment, the circuitry 202 may be configured to determine the cost associated with the one or more first digital products 116 for the first user (e.g., the user 126), based on the demand information 304A for the one or more first digital products 116 among the set of digital products 114 associated with the set of digital platforms 118. The determination of the cost associated with the one or more first digital products is described further, for example, in FIG. 3 (at 304).

At 1908, the metadata 110 associated with the one or more first digital products 116 may be determined, based on the received first subscription request and the determined cost associated with one or more first digital products 116. In an embodiment, the circuitry 202 may be configured to determine the metadata 110 associated with the one or more first digital products 116, based on the received first subscription request and the determined cost associated with the one or more first digital products 116. The determination of the metadata is described further, for example, in FIG. 3 (at 306).

At 1910, the one or more first non-fungible tokens (NFTs) 112 associated with the one or more first digital products 116 may be created, wherein each of the one or more first NFTs 112 is created based on a storage of the determined metadata 110 to the first distributed ledger 108 associated with each of the set of digital platforms 118. In an embodiment, the circuitry 202 may be configured to create the one or more first non-fungible tokens (NFTs) 112 associated with the one or more first digital products 116. Each of the one or more first NFTs 112 is created based on a storage of the determined metadata 110 to the first distributed ledger 108 associated with each of the set of digital platforms 118. The creation of the one or more first NFTs is described further, for example, in FIG. 3 (at 308).

At 1912, the second subscription request associated with the second user (e.g., a user other than the user 126) may be received for the second digital product 116B, from the one or more first digital products 116, associated with the set of digital platforms 118. The circuitry 202 may be configured to receive the second subscription request associated with the second user, for the second digital product 116B, from the one or more first digital products 116, associated with the set of digital platforms 118. The second subscription request may correspond to the second user-right 122B of the second user for the second digital product 116B. The reception of the second subscription request is described further, for example, in FIG. 3 (at 310).

At 1914, from the one or more first NFTs 112 on the first distributed ledger 108, the second NFT 120 associated with the second digital product 116B may be retrieved, based on the received second subscription request. The circuitry 202 may be configured to retrieve, from the created one or more first NFTs 112 on the first distributed ledger 108, the second NFT 120 associated with the second digital product 116B, based on the received second subscription request. The retrieval of the second NFT associated with the second digital product is described further, for example, in FIG. 3 (at 312)

At 1916, the ownership or the usage of the second digital product 116B associated with the set of digital platforms 118 may be controlled, based on the retrieved second NFT 120. The circuitry 202 may be configured to control the ownership or the usage of the second digital product 116B associated with the set of digital platforms 118, based on the retrieved second NFT 120. Control may pass to end.

Although the flowchart 1900 is illustrated as discrete operations, such as, 1904, 1906, 1908, 1910, 1912, 1914 and 1916, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102). Such instructions may cause the electronic device 102 to perform operations that may include reception of a first subscription request associated with a first user (such as, the user 126), for one or more first digital products (such as, the one or more first digital products 116), from a set of digital products (such as, the set of digital products 114) associated with a set of digital platforms (such as, the set of digital platforms 118). The first subscription request may correspond to a first user-right (such as, the first user-right 122A) of the first user (such as, the user 126) for the one or more first digital products 116. The operations may further include determination of a cost associated with the one or more first digital products 116 for the first user (e.g., the user 126), based on demand information (such as, the demand information 304A) for the one or more first digital products 116 among the set of digital products 114 associated with the set of digital platforms 118. The operations may further include determination of metadata (such as, the metadata 110) associated with the one or more first digital products 116, based on the received first subscription request and the determined cost associated with the one or more first digital products 116. The operations may further include creation of one or more first non-fungible tokens (NFTs) (such as, the one or more first NFTs 112) associated with the one or more first digital products 116. Each of the one or more first NFTs 112 may be created based on a storage of the determined metadata 110 to a first distributed ledger (such as, the first distributed ledger 108) associated with each of the set of digital platforms 118. The operations may further include reception of a second subscription request associated with a second user (such as, a user other than the user 126), for a second digital product (such as the second digital product 116B), from the one or more first digital products 116, associated with the set of digital platforms 118. The second subscription request may correspond to a second user-right (such as the second user right 122B) of the second user for the second digital product 116B. The operations may further include retrieval, from the created one or more first NFTs 112 on the first distributed ledger 108, a second NFT (such as the second NFT 120) associated with the second digital product 116B, based on the received second subscription request. The operations may further include a control of an ownership or usage of the second digital product 116B associated with the set of digital platforms 118, based on the retrieved second NFT 120.

Exemplary aspects of the disclosure may provide an electronic device (such as, the circuitry 202 of FIG. 1) that includes circuitry (such as, the circuitry 202). The circuitry 202 may be configured to receive a first subscription request associated with a first user (e.g., the user 126), for a one or more first digital products (e.g., the one or more first digital products 116), from a set of digital products (e.g., the set of digital products 114), from a set of digital platforms (e.g., the set of digital platforms 118). The set of digital products 114 may correspond to at least one of a television service, a streaming media service, an Over-The-Top (OTT) service, a music streaming service, a gaming service, a digital artwork, online food delivery service, online groceries delivery service, an e-commerce service, a commission-based service, a pay-per-use service, a subscription-based service, or an NFT-based content, product or service. The first subscription request corresponds to a first user-right (e.g., the first user-right 122A) of the first user (e.g., the user 126) for the one or more first digital products 116. The circuitry 202 may be configured to determine a cost associated with the one or more first digital products 116 for the first user (e.g., the user 126), based on demand information (e.g., the demand information 304A) for the one or more first digital products 116 among the set of digital products 114 associated with the set of digital platforms 118. The circuitry 202 may be configured to determine metadata (e.g., the metadata 110) associated with the one or more first digital products 116, based on the received first subscription request and the determined cost associated with the one or more first digital products 116. In an embodiment, the circuitry 202 may be configured to receive a user input indicative of an approval of the determined cost. The determination of the metadata 110 may further based on the user input indicative of the approval of the rendered cost. The circuitry 202 may create one or more first NFTs (e.g., the one or more first NFTs 112) associated with the one or more first digital products 116. Each of the one or more first NFTs 112 may be created based on a storage of the determined metadata 110 to a first distributed ledger (e.g., the first distributed ledger 108) associated with each of the set of digital platforms 118. The circuitry 202 may be configured to receive a second subscription request associated with a second user (for example, a user other than the user 126), for a second digital product 116B, from the one or more first digital products 116, associated with the set of digital platforms 118. The second subscription request may correspond to a second user-right (e.g., the second user-right 122B) of the second user for the second digital product 116B. Further, the circuitry 202 may retrieve, from the created one or more first NFTs 112 on the first distributed ledger 108, a second NFT (e.g., the second NFT 120) associated with the second digital product 116B, based on the received second subscription request. Examples of the first user-right 122A and second user-right 122B may include, but are not limited to, ownership right, a modification right, a renting right, a time-share right, an exchanging right, or a derivative creation right. Accordingly, the circuitry 202 may control an ownership or a usage of the second digital product 116B associated with the set of digital platforms 118, based on the retrieved second NFT 120.

In an embodiment, the first user-right 122A may be the same as the second user-right 122B, and in another embodiment the first user-right 122A may be different from the second user-right 122B.

In an embodiment, the demand information 304A may correspond to at least one of usage information indicative of a usage of the set of digital products 114 by a set of users associated with the set of digital platforms 118, advertisement information (e.g., the advertisement information 702A) associated with the set of digital products 114, or demographic information (e.g., the demographic information 304D) of the set of users associated with the set of digital platforms 118.

In an embodiment, the circuitry 202 may be configured to receive the set of historical subscription information related to a set of users associated with the set of digital platforms 118. The circuitry 202 may further apply the AI model 404A on received set of historical subscription information. Further, the circuitry 202 may be configured to determine the demand information 304A based on the application of an AI model (e.g., the AI model 404A).

In an embodiment, the circuitry 202 may be configured to determine one or more subscription packs associated with the one or more first digital products 116, based on the determined demand information 304A and the received first subscription request. The circuitry 202 may be configured to receive a user input indicative of a selection of a first subscription pack from the determined one or more subscription packs. Based on the received user input indicative of the selection of the first subscription pack, the circuitry 202 may select the first subscription pack from the determined one or more subscription packs. The determination of the metadata 110 may be further based on the selected first subscription pack.

In an embodiment, the circuitry 202 may be configured to receive a product exchange request associated with the first user (e.g., the user 126), for exchange of the first digital product 116A with a third digital product (e.g., the third digital product 502B). The one or more first digital products 116 may include the first digital product, and the one or more second digital products associated with a third user (e.g., the third user 502A) include the third digital product 502B. The circuitry 202 further may retrieve, from the one or more first NFTs 112 on the first distributed ledger 108, a third NFT (e.g., the third NFT 504A) associated with the first digital product 116A. The circuitry 202 may further retrieve, from one or more second NFTs on the second distributed ledger 506B, a fourth NFT (e.g., the fourth NFT 506C) associated with the third digital product 502B. The circuitry 202 may further store the retrieved third NFT 504A on a second distributed ledger (e.g., the second distributed ledger 506B), and store the retrieved fourth NFT 506C on the first distributed ledger 108. The first digital product 116A may be exchanged with the third digital product 502B based on the storage of the third NFT 504A on the second distributed ledger 506B and the storage of the fourth NFT 506C on the first distributed ledger 108.

In an embodiment, the first user (e.g., the user 126) may be different from the third user, and in another embodiment, the first user may be the same as the third user.

In an embodiment, the circuitry 202 may be configured to track a usage of the one or more first digital products 116 by the user 126. Further, the circuitry 202 may apply the AI model 404A on the tracked usage and the on determined cost. The circuitry 202 further may determine reward information for the usage of the one or more first digital products 116 by the first user (e.g., the user 126), based on the application of the AI model 404A.

In an embodiment, the circuitry 202 may be configured to render the advertisement information 702A to be consumed by the first user (e.g., the user 126), based on the one or more first digital products 116. Further, the circuitry 202 may track a consumption of the rendered advertisement information 702A by the user 126. The circuitry 202 further may apply the AI model 404A on the tracked consumption of the rendered advertisement information 702A. Based on the application of the AI model 404A, the circuitry 202 may determine reward information associated with the rendered advertisement information 702A.

In an embodiment, the circuitry 202 may be configured to receive reward information for the one or more first digital products 116 associated with the first user (e.g., the user 126). The circuitry 202 further may receive a purchase request for a fourth digital product (e.g., the fourth digital product 804A) based on the received reward information. The circuitry 202 further may receive metadata associated with the fourth digital product 804A, based on the received reward information and the received purchase request. The circuitry 202 further may create a fifth NFT (e.g., the fifth NFT 808A) associated with the fourth digital product 804A based on a storage of the received metadata 110 to the first distributed ledger 108 associated with each of the set of digital platforms 118. Further, the circuitry 202 may control the ownership or the usage of the fourth digital product 804A, based on the created fifth NFT 808A.

In an embodiment, the circuitry 202 may be configured to virtually charge a first NFT-based Internet-of-Things (IoT) card (e.g., the first NFT-based loT card 1710), based on the control of the ownership or the usage of the second digital product 116B. A second NFT-based loT card may be charged based on the virtually charged first NFT-based loT card 1710.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive a first subscription request associated with a first user, for one or more first digital products, from a set of digital products associated with a set of digital platforms, wherein
the first subscription request corresponds to a first user-right of the first user for the one or more first digital products;
determine a cost associated with the one or more first digital products for the first user, based on demand information for the one or more first digital products among the set of digital products associated with the set of digital platforms;
determine metadata associated with the one or more first digital products, based on the received first subscription request and the determined cost associated with the one or more first digital products;
create one or more first non-fungible tokens (NFTs) associated with the one or more first digital products, wherein
each of the one or more first NFTs is created based on a storage of the determined metadata to a first distributed ledger associated with each of the set of digital platforms;
receive a second subscription request associated with a second user, for a second digital product, from the one or more first digital products, associated with the set of digital platforms, wherein
the second subscription request corresponds to a second user-right of the second user for the second digital product;
retrieve, from the created one or more first NFTs on the first distributed ledger, a second NFT associated with the second digital product, based on the received second subscription request; and
control an ownership or a usage of the second digital product associated with the set of digital platforms, based on the retrieved second NFT.

2. The electronic device according to claim 1, wherein the set of digital products corresponds to at least one of a television service, a streaming media service, an Over-The-Top (OTT) service, a music streaming service, a utility service, a digital artwork, online food delivery service, online groceries delivery service, an e-commerce service, a commission-based service, a pay-per-use service, a subscription-based service, or an NFT-based content, product or service.

3. The electronic device according to claim 1, wherein each of the first user-right and the second user-right includes at least one of an ownership right, a modification right, a renting right, a time-share right, an exchanging right, or a derivative creation right.

4. The electronic device according to claim 1, wherein the first user-right is same as the second user-right.

5. The electronic device according to claim 1, wherein the first user-right is different from the second user-right.

6. The electronic device according to claim 1, wherein the demand information corresponds to at least one of usage information indicative of a usage of the set of digital products by a set of users associated with the set of digital platforms, advertisement information associated with the set of digital products, or demographic information of the set of users associated with the set of digital platforms.

7. The electronic device according to claim 1, wherein the circuitry is further configured to:
receive a set of historical subscription information related to a set of users associated with the set of digital platforms;
apply an artificial intelligence (AI) model on received set of historical subscription information; and
determine the demand information based on the application of the AI model.

8. The electronic device according to claim 7, wherein the circuitry is further configured to:
determine one or more subscription packs associated with the one or more first digital products, based on the determined demand information and the received first subscription request;
receive a user input indicative of a selection of a first subscription pack from the determined one or more subscription packs; and
select the first subscription pack from the determined one or more subscription packs, based on received user input indicative of the selection of the first subscription pack, wherein
the determination of the metadata is further based on the selected first subscription pack.

9. The electronic device according to claim 1, wherein the circuitry is further configured to:
receive a user input indicative of an approval of the determined cost, wherein
the determination of the metadata is further based on the user input indicative of the approval of the rendered cost.

10. The electronic device according to claim 1, wherein the circuitry is further configured to:
receive a product exchange request associated with the first user, for exchange of a first digital product with a third digital product, wherein
the one or more first digital products include the first digital product, and one or more second digital products associated with a third user include the third digital product;
retrieve, from the one or more first NFTs on the first distributed ledger, a third NFT associated with the first digital product;
retrieve, from one or more second NFTs on a second distributed ledger, a fourth NFT associated with the third digital product;
store the retrieved third NFT on the second distributed ledger; and
store the retrieved fourth NFT on the first distributed ledger, wherein
the first digital product is exchanged with the third digital product based on the storage of the third NFT on the second distributed ledger and the storage of the fourth NFT on the first distributed ledger.

11. The electronic device according to claim 10, wherein the first user is different from the third user.

12. The electronic device according to claim 10, wherein the first user is same as the third user.

13. The electronic device according to claim 1, wherein the circuitry is further configured to:
track a usage of the one or more first digital products by the first user;
apply an AI model on the tracked usage and the on determined cost; and
determine reward information for the usage of the one or more first digital products by the first user, based on the application of the AI model.

14. The electronic device according to claim 1, wherein the circuitry is further configured to:
render advertisement information to be consumed by the first user, based on the one or more first digital products;
track a consumption of the rendered advertisement information by the first user;
apply an AI model on the tracked consumption of the rendered advertisement information; and
determine reward information associated with the rendered advertisement information, based on the application of the AI model.

15. The electronic device according to claim 1, wherein the circuitry is further configured to:
receive reward information for the one or more first digital products associated with the first user;
receive a purchase request for a fourth digital product based on the received reward information;
receive metadata associated with the fourth digital product, based on the received reward information and the received purchase request; and
create a fifth NFT associated with the fourth digital product based on a storage of the determined metadata to the first distributed ledger associated with each of the set of digital platforms; and
control the ownership or the usage of the fourth digital product, based on the created fifth NFT.

16. The electronic device according to claim 1, wherein the circuitry is further configured to virtually charge a first NFT-based Internet-of-Things (IoT) card, based on the control of the ownership or the usage of the second digital product.

17. The electronic device according to claim 16, wherein a second NFT-based loT card is charged based on the virtually charged first NFT-based loT card.

18. A method, comprising:
in an electronic device:
receiving a first subscription request associated with a first user, for one or more first digital products, from a set of digital products associated with a set of digital platforms, wherein
the first subscription request corresponds to a first user-right of the first user for the one or more first digital products;
determining a cost associated with the one or more first digital products for the first user, based on demand information for the one or more first digital products among the set of digital products associated with the set of digital platforms;
determining metadata associated with the one or more first digital products, based on the received first subscription request and the determined cost associated with the one or more first digital products;
creating one or more first non-fungible tokens (NFTs) associated with the one or more first digital products, wherein
each of the one or more first NFTs is created based on a storage of the determined metadata to a first distributed ledger associated with each of the set of digital platforms;
receiving a second subscription request associated with a second user, for a second digital product, from the one or more first digital products, associated with the set of digital platforms, wherein
the second subscription request corresponds to a second user-right of the second user for the second digital product;
retrieving, from the created one or more first NFTs on the first distributed ledger, a second NFT associated with the second digital product, based on the received second subscription request; and
controlling an ownership or a usage of the second digital product associated with the set of digital platforms, based on the retrieved second NFT.

19. The method according to claim 18, wherein the set of digital products corresponds to at least one of a television service, a streaming media service, an Over-The-Top (OTT) service, a music streaming service, a utility service, a digital artwork, online food delivery service, online groceries delivery service, an e-commerce service, a commission-based service, a pay-per-use service, a subscription-based service, or an NFT-based content, product or service.

20. A non-transitory computer-readable medium having stored thereon, computer-executable instructions that when executed by an electronic device, causes the electronic device to execute operations, the operations comprising:
receiving a first subscription request associated with a first user, for one or more first digital products, from a set of digital products associated with a set of digital platforms, wherein
the first subscription request corresponds to a first user-right of the first user for the one or more first digital products;
determining a cost associated with the one or more first digital products for the first user, based on demand information for the one or more first digital products among the set of digital products associated with the set of digital platforms;
determining metadata associated with the one or more first digital products, based on the received first subscription request and the determined cost associated with the one or more first digital products;
creating one or more first non-fungible tokens (NFTs) associated with the one or more first digital products, wherein
each of the one or more first NFTs is created based on a storage of the determined metadata to a first distributed ledger associated with each of the set of digital platforms;
receiving a second subscription request associated with a second user, for a second digital product, from the one or more first digital products, associated with the set of digital platforms, wherein
the second subscription request corresponds to a second user-right of the second user for the second digital product;
retrieving, from the created one or more first NFTs on the first distributed ledger, a second NFT associated with the second digital product, based on the received second subscription request; and
controlling an ownership or a usage of the second digital product associated with the set of digital platforms, based on the retrieved second NFT.
